(19) United States
(12) Patent Application Publication
(10) Pub. No.: US 2011/0211779 A1
(43) Pub. Date: Sep. 1, 2011

(54) SLIDE MODULE AND APPARATUS WITH SLIDE PART UTILIZING THE SAME

(76) Inventor: Han Sang LEE, Seoul (KR)

(21) Appl. No.: 13/027,684

(22) Filed: Feb. 15, 2011

(30) Foreign Application Priority Data
Feb. 26, 2010 (KR) 10-2010-0017827

(51) Int. Cl. F16C 29/02

(52) U.S. Cl. 384/26

(57) ABSTRACT

A slide module obtaining a moving power while a slide body moves along a guide surface is provided. The slide module comprises: a guide portion having a first guide surface and a second guide surface forming a circumnavigating track; a slide body installed so as to circumnavigate along the circumnavigating track, and a first tilt-pressing member having a first tilt-pressing surface facing toward the first guide surface; a first tilt-pressing device having a first pressing means for pressing the first tilt-pressing member against the guide surface; and a second tilt-pressing device having a second tilt-pressing member with a second tilt-pressing surface facing toward the second guide surface and a second pressing means for pressing the second tilt-pressing member against the second guide surface, wherein if the slide body proceeds between the first guide surface and the first tilt-pressing surface by external force, the first tilt-pressing member tilt-presses the slide body with respect to the first guide surface by a pressing force provided by the first pressing means, and if the slide body proceeds between the second guide surface and the second tilt-pressing surface by external force, the second tilt-pressing member tilt-presses the slide body with respect to the second guide surface by a pressing force provided by the second pressing means.

### FIELD OF INVENTION

The invention relates to a slide module and apparatus with a slide part using the same, and more specifically to a slide module obtaining moving power using a guide surface and a mechanical operation mechanism and apparatus with a slide part using the same.

### BACKGROUND OF INVENTION

The shape of portable terminals such as mobile phone, portable game machine, PDA, electronic scheduler, electronic dictionary, notebook computer, net-book computer, etc. keeps changing. Flip types, bar types, and folder types of mobile phone have been well known, and the slide type of mobile phones are developed already and on the market widely.

A conventional type obtaining moving power using a wall surface includes a structure for obtaining moving power of the sliding plate against the guide rail, in which a guide rail having a tilted portion is formed on one sliding plate, and one the other guide plate is installed a slider and the like that is elastically supported by a spring on a tilted side surface of the guide rail.

### PRIOR ARTS

### Patent Documents

The conventional types obtaining moving power using wall surfaces as described in the above are disclosed in U.S. Pat. No. 7,184,806 B2 (Chul-Ho Bae, issued on Feb. 27, 2007) and U.S. Pat. No. 7,257,432 (Ling-Han Nan, issued on Aug. 14, 2007).

### TECHNOLOGY OF INVENTION

### Problem to Solve

The conventional types obtaining moving power using wall surfaces as described in the above must be applied with an external force over a half of the entire moving section while moving and opening the slider in a direction and then returning and closing again.

Also, in the above conventional types, the components are hard to manufacture because the wall surface must be formed atilt with respect to the moving direction of the slider.

Also, in the above conventional types, there are problems that the tilt of the wall surface must be small in order to make the moving distance of the slider long, resulting that the force to move the slider is lessened, and that the tilt of the wall surface must be large in order to make the moving power of the slider large, resulting that the distance to move the slider is lessened.

Since the wall surface must be formed atilt with respect to the moving direction of the slider, the components are hard to manufacture.

Also, in the conventional types, the force applied to the wall surface by a spring on a corresponding location is same both in moving and opening the slider in one direction and in returning. Therefore, it is difficult to apply the conventional types to a case in which the moving power for moving the slider in one direction is different from the moving power for returning, for example, in a door open/closing upward and downward where the gravity acts on the slider.

Furthermore, since when returning after moving the slider in one direction the conventional types use the same wall surface as used when moving in the one direction, the procedure for moving in one direction is processed oppositely to the procedure for returning. Therefore, it is impossible to stop at a location in opening the slider but not to stop at the same location in returning.

An object of the invention is to provide a slide module, which can move a slide body in one direction and then return again by applying external force over a partial section that is much smaller than a half of the entire moving section.

Another object of the invention is to provide a slide module, which can move the slide body irrespective of the tilt of a guide surface with respect to a moving direction of the slide body.

Still another object of the invention is to provide a slide module, which can change the force applied to the guide surface by a spring at corresponding locations of moving and returning, a moving path, a stopping position, etc. by differentiating a guide surface used for moving the slide body in one direction from a guide surface used for returning.

Still another object of the invention is to provide a slide module, which can be easily installed wherever needed without changing structures of an object or device.

Still another object of the invention is to provide a slide module, which can move the slide body with a large force while increasing the moving distance of the slide body compared to the prior arts.

Still another object of the invention is to provide a slide module, in which the slide body can circumnavigate along a circumnavigating track.

Still another object of the invention is to provide a slide module, which can rotate an object to move.

Still another object of the invention is to provide an apparatus having a slide part with slide module according to the present invention.

### Solutions to Problem

A slide module according to the present invention comprises: a guide portion having a first guide surface and a second guide surface forming a circumnavigating track; a slide body installed so as to circumnavigate along the circumnavigating track, a first tilt-pressing device having a first tilt-pressing member with a first tilt-pressing surface facing toward the first guide surface and a first pressing means for pressing the first tilt-pressing member against the first guide surface; and a second tilt-pressing device having a second tilt-pressing member with a second tilt-pressing surface facing toward the second guide surface and a second pressing means for pressing the second tilt-pressing member against the second guide surface, wherein if the slide body proceeds between the first guide surface and the first tilt-pressing surface by external force, the first tilt-pressing member tilt-presses the slide body with respect to the first guide surface by a pressing force provided by the first pressing means, and if the slide body proceeds between the second guide surface and the second tilt-pressing surface by external force, the second tilt-pressing member tilt-presses the slide body with respect to the second guide surface by a pressing force provided by the second pressing means.

Preferably, if the slide body proceeds between the first guide surface and the first tilt-pressing surface by an external force from a first stationary state at one edge of the circumnavigating track, the first tilt-pressing member retreats with respect to the first guide surface, then returns to an original state by a pressing force provided by the first pressing means, and tilt-presses the slide body so as to move toward the other edge of the circumnavigating track along the first guide surface, and if the slide body proceeds between the second guide surface and the second tilt-pressing surface by an external force from a second stationary state at the other edge of the circumnavigating track, the second tilt-pressing member retreats with respect to the second guide surface, then returns to an original state by a pressing force provided by the second pressing means, and tilt-presses the slide body so as to move toward the one edge of the circumnavigating track along the second guide surface.

In cases, if the slide body proceeds between the first guide surface and the first tilt-pressing surface by an external force from a first stationary state at one edge of the circumnavigating track, the first tilt-pressing member retreats with respect to the first guide surface, then returns to an original state by a pressing force provided by the first pressing means, and tilt-presses the slide body so as to move toward the other edge of the circumnavigating track along the first guide surface, and if the slide body proceeds between the second guide surface and the second tilt-pressing surface by an external force from a second stationary state at the other edge of the circumnavigating track, the second tilt-pressing member tilt-presses the slide body by a pressing force provided by the second pressing means while retreating with respect to the second guide surface, acts a force interfering the slide body from moving toward the one edge of the circumnavigating track along the second guide surface, and returns to the original state if the slide body overcomes the above interfering force with an external force and escapes to the first stationary state.

Each of the first and second guide surfaces comprises linear moving sections elongated in a direction of length and direction-changing sections bent or curved smoothly from both ends of the linear moving sections, and the direction-changing sections of the first and second guide surfaces are connected to each other, making an athletics track or similar shape.

Preferably, the first tilt-pressing member or the second tilt-pressing member is installed rotatably at a position distant from an edge of the guide portion or moving along a limited section, and, by changing the angle tilt-opening with respect to a guide surface according to the position of the slide body inserted between the guide surface facing therewith, presses the slide body toward one side with respect to the facing guide surface. In the other end of the first tilt-pressing member is formed a first bending portion for holding the slide body by pressing the slide body against the one side of the second tilt-pressing member so as not to move after pushing and moving the slide body toward the second guide surface at a location where the first guide surface ends, and in the other end of the second tilt-pressing member is formed a second bending portion for holding the slide body by pressing the slide body against the one side of the first tilt-pressing member so as not to move after pushing and moving the slide body toward the first guide surface at a location where the second guide surface ends.

At each of both ends of the circumnavigating track is provided an external force acting section for the slide body to stay at a stationary state and then proceed between the first guide surface and the first tilt-pressing member or between the second guide surface and the second tilt-pressing member by an external force.

Along the gap between the first guide surface and the second guide surface is formed a first guide member, and in the first guide member may be installed a first guiding member, which is connected to the slide body, installed movably along the first guide member, and guides the slide body to circumnavigate the first and second guide surfaces without dislocating while moving with the slide body.

In cases, the guide portion comprises a dislocation-preventing portion which covers top portions of the first and second guide surfaces, a surface of the first body and the dislocation-preventing portion form a side groove along the first and second guide surface, and the slide body is installed such that a part thereof is inserted in the side groove and glide-and-moves while inserted and trapped in the side groove.

The slide module may further comprise a first body in which the guide portion is installed, and a second body engaged with the first body with the first tilt-pressing device, the second tilt-pressing device, and the slide body between the first body and itself, and preferably at least in one side of the assembly of the first and second bodies is formed an open portion for delivering a power of the slide body to outside.

In the second body is formed an opening in a direction of length of the first guide surface and the second guide surface, along both sides of the direction of length of the opening is formed a second guide member, in the second guide member is installed movably a second guiding member in a direction of length of the opening, in the second guiding member is formed an oblong hole for allowing the slide body to move in a direction of width of the second guide member, and the slide body may be connected to the second guiding member through the oblong hole.

At an edge of the first tilt-pressing member or the second tilt-pressing member are disposed more than two protrusions with an interval, at least in an edge of the guide portion is formed a protrusion guide in which the more than two protrusions are inserted and guided at a position away from the guide portion, and the protrusion guide preferably comprises a bent portion allowing the first tilt-pressing member or the second tilt-pressing member to move along the limited section and to rotate.

When it moves from one end of the circumnavigating track to the other end, the slide body passes a peak point of the other end and then stops, and when it moves from the other end of the circumnavigating track to the one end, the slide body passes a peak point of the one end and then stops.

Upper end and lower end of each of the first tilt-pressing member and the second tilt-pressing member pass and extend beyond the upper end and the lower end of the circumnavigating track, and the extended parts limit the slide body at both ends of the circumnavigating track.

Preferably the first pressing means and the second pressing means may comprise a spring with elasticity.

The first guide surface and the second guide surface comprises grooves or protrusions formed along the side surfaces thereof, and at least a part of the slide body is engaged with the grooves or protrusions and guided thereby.

In cases, a slide module according to the invention comprises: a guide portion having a guide surface; a slide body installed movably along the guide surface; and a first tilt-pressing device having a tilt-pressing member with a tilt-pressing surface facing toward the guide surface and installed rotatably while moving around a position away from the guide surface as a center or in a limited section, and a pressing means for pressing the tilt-pressing member toward the guide surface, wherein if the slide body is inserted between the tilt-pressing surface and the guide surface, the tilt-pressing member is configured to apply a force for moving the slide body along the guide surface from a first position with a smaller interval against the guide surface to a second position with a larger interval, by pressing the slide body toward one side with respect to the guide surface by a pressing force that the pressing means provide while the angle tilt-opening against the guide surface changes.

The guide surface is disposed along a shape selected from the group consisting a circle, an ellipse, and polygons, and two or more tilt-pressing devices may be disposed along a perimeter of the guide portion.

The guide surface is disposed along a circle, two or more first tilt-pressing devices are installed along a perimeter of the guide portion, and two or more slide bodies may be installed with intervals.

An apparatus having a slide module according to the present invention comprises: a slide module; a moving member which engages a slide body of the slide module or a connection member connected to the slide body and performs a linear reciprocation or circumnavigation or rotation along an arbitrary closed path; and a supporting member for supporting the slide module such that the moving member moves according to the movement of the slide body.

### Effect of Invention

A slide module according to the invention can move in a direction and return a slide body by applying an external force only to a partial segment which is much smaller than the prior arts.

A slide module according to the invention can rotate the slide body around a guide portion in a direction.

A slide module according to the invention increases the power and the distance for moving the slide body compared to the prior arts, because the tilt-pressing member rotates and pushes the slide body.

A slide module according to the invention may change the operational process of the slide body and the power and path for moving the slide body, because the guide surface used when the slide body moves in a direction is different from the guide surface used for returning.

A slide module according to the invention may be installed easily in an object or device without changing the structure by much, because two parts may be able to slide with respect to each other just by connecting the slide body or a portion connected to the slide body to the other part with screws, etc. while a second part is attached to one part.

A slide module according to the invention increases the moving distance of the slide body and moves the slide body with a large force at the same time, and makes it easy to manufacture components, because it does not need to make the guide surface tilted.

A slide module according to the invention can rotate an object to move in one place.

### BRIEF DESCRIPTION OF DRAWINGS

FIG. 1 is a perspective view showing a slide module according to the present invention;

FIG. 2 is a perspective bottom view showing the slide module of FIG. 1;

FIG. 3 is a perspective exploded view showing a first body detached from a second body of the slide module of FIG. 1;

FIG. 4 is a perspective exploded view showing the slide module of FIG. 1;

FIGS. 5-10 are plan views showing the step-by-step operation of the slide module of FIG. 1;

FIG. 11 is a plan view showing a variant of the slide module of FIG. 1;

FIGS. 12 and 13 are plan views showing another variants of the slide module of FIG. 1;

FIG. 14 is a plan view showing still another variant of the slide module of FIG. 1;

FIG. 15 is a perspective view showing a slide module according to another embodiment of the present invention;

FIG. 16 is a perspective bottom view showing the slide module of FIG. 15;

FIG. 17 is a perspective exploded view showing inside of the slide module of FIG. 15;

FIG. 18 is a perspective exploded view showing the slide module of FIG. 15;

FIG. 19 is a perspective exploded view showing a variant of the slide module of FIG. 18;

FIG. 20 is a plan view showing another variant of the slide module shown in FIGS. 1-4;

FIG. 21 is a plan view showing still another variant of the slide module shown in FIGS. 1-4;

FIG. 22 is a plan view showing a mobile electronic device adopting a slide module according to the present invention;

FIG. 23 is a perspective exploded view showing the mobile electronic device of FIG. 22;

FIG. 24 is a perspective exploded view showing the mobile electronic device of FIG. 23 flipped top to bottom;

FIG. 25 is an exploded view showing a state in which a slide module according to the present invention is applied to a drawer;

FIG. 26 is a perspective view showing a state in which a slide module according to the present invention is applied to a revolving door;

FIG. 27 is a plan view showing a slide module according another embodiment of the present invention;

FIG. 28 is a cross-sectional view showing other example of a guide portion;

FIG. 29 is a diagram showing variants of a guide surface and a slide body;

FIG. 30 is a plan view showing a slide module according still another embodiment of the present invention;

FIG. 31 is a plan view showing a slide module according to still another embodiment of the present invention; and

FIG. 32 is a plan view showing a variant of the slide module of FIG. 5.

### DETAILED DESCRIPTION OF EMBODIMENTS OF INVENTION

Below, the invention is described in detail referring to the figures.

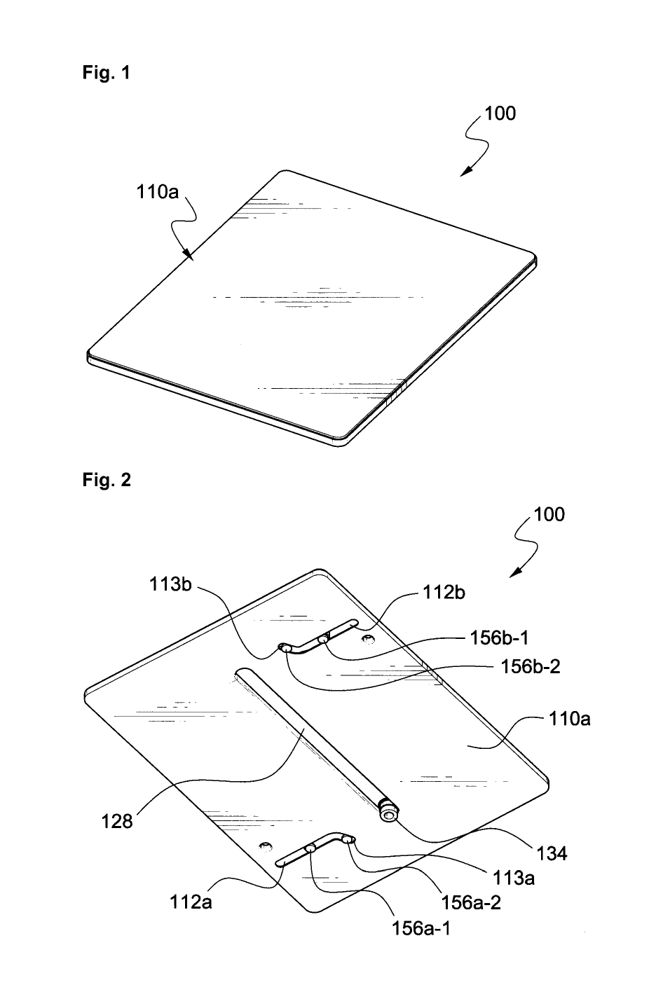

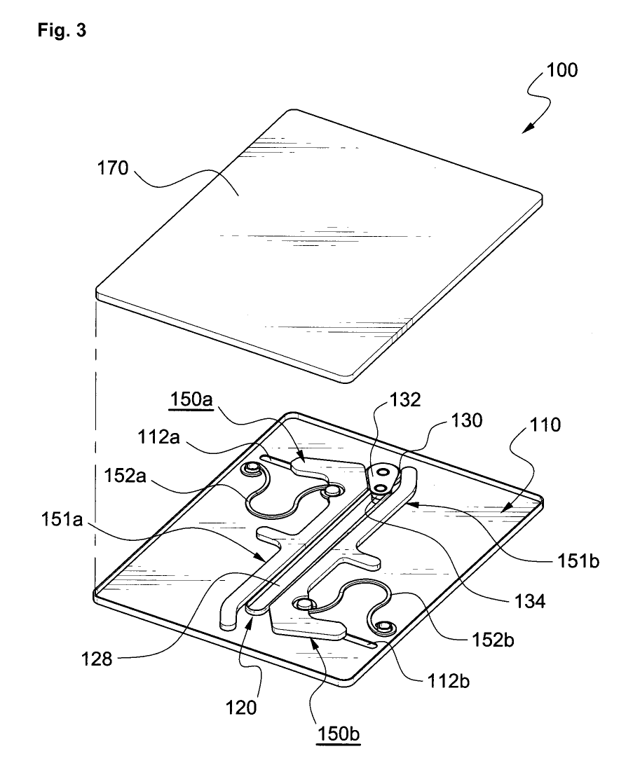

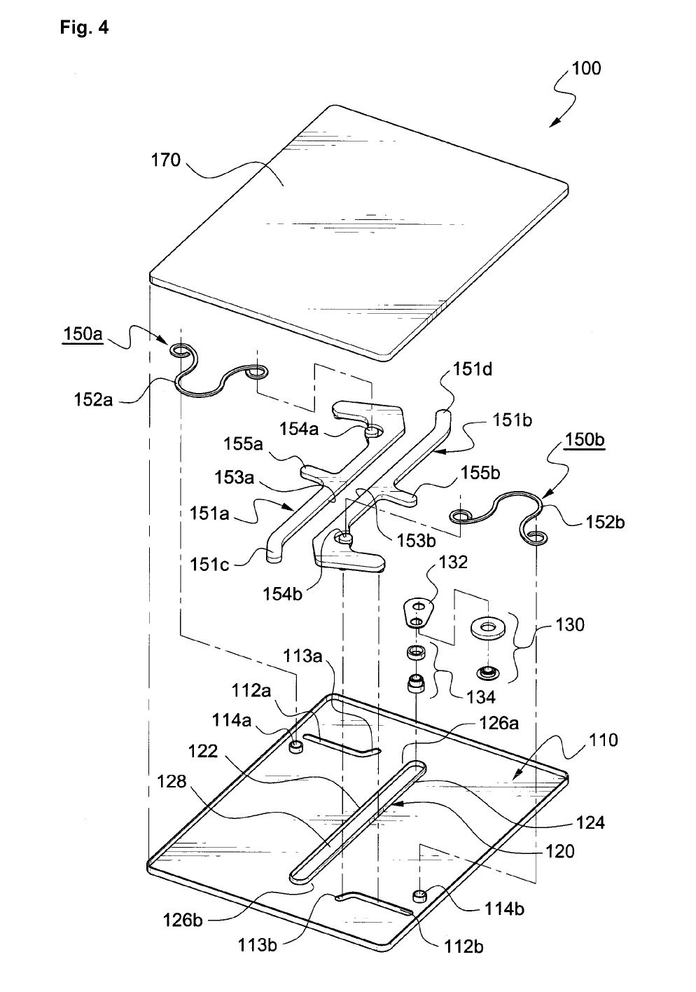

FIG. 1 is a perspective view showing a slide module according to the present invention, FIG. 2 is a perspective bottom view showing the slide module of FIG. 1, FIG. 3 is a perspective exploded view showing a first body detached from a second body of the slide module of FIG. 1, and FIG. 4 is a perspective exploded view showing the slide module of FIG. 1.

As shown in FIGS. 1-4, a slide module 100 according to the invention comprises a planar first body 110. In a central portion of the first body 110 is formed a guide portion 120 having a guide surface. The guide portion 120 preferably is formed by connecting two curved sections (or direction-changing sections) guide surface and two linear sections (or linear-moving sections) in a shape of athletics track (the length of the two linear section guide surfaces is much longer than the width between the two linear section guide surfaces). Preferably, considering the operation mechanism the guide surface may be divided into first guide surface 122 and second guide surface 124 disposed on both sides of a center line crossing midpoints of the two linear sections. The first guide surface 122 and second guide surface 124 extend upward from a surface of the first body 110. The reason both ends of the two guide surfaces 122, 124 are made of the curved section guide surfaces is to make a slide body 130 slide and move easily by an external force from a stationary state, and it may be made in different shapes and structures if they allow such a movement.

In this embodiment, the guide portion 120 is shown to be formed in the central portion of the first body 110 preferably, but it may be formed in different location and in forms different from the planar first body 110.

At both ends of the first guide surface 122 and the second guide surface 124 have to be provided external force acting sections 126a, 126b for applying external forces in order to insert the slide body 130 held in a first stationary state in an upper end between the first guide surface 122 and a first tilt-pressing member 151a and in order to insert the slide body 130 held in a second stationary state in a lower end between the second guide surface 124 and a second tilt-pressing member 151b, which will be described in detail later. To these external force acting sections 126a, 126b is applied an external force in a desired direction for moving the slide body 130 through the slide body 130 or a first guide member 134 connected to the slide body 130 through a connecting member 132. These external force acting sections 126a, 126b are much shorter than external force acting sections for a conventional slide module.

Here, when moving from the first stationary state to the second stationary state the slide body 130 passes a peak point of the lower end surface of the track and reaches the second stationary state, and when moving from the second stationary state to the first stationary state the slide body 130 passes a peak point of the upper end surface of the track and reaches the first stationary state. Below, when the slide body 130 circumnavigates around the track, it may be called a circumnavigating track.

Between the first guide surface 122 and the second guide surface 124 is formed a first guide member 128 having a form of through hole. The first guide member 128 performs mainly guiding of the movement of the first guide member 134. Also, it performs a function of a path through which the slide body 130 engages or is connected to an external object to move (the moving power of the slide body 130 is transferred to the external object through the connection or engagement). Since such a connecting path may be provided in a different form, the first guide member 128 does not have to be provided in the form of through hole. For example, the first guide member 128 is formed in the first guide member 134 as a form of guiding groove, and it is possible to form a through hole in a second body 170 for a connecting path. In other embodiment, it is possible to provide the first guide member 128 as a form of through hole in the second body 170, not in the first body 110. In still another embodiment, if the first body 110 is attached to one portion of the object to move without the second body 170, on a surface of the object to move may be formed the first guide member 128.

On the upper left side and the lower right side of the first guide member 128, that is, in a vicinity of one end of the first tilt-pressing member 151a and one end of the second tilt-pressing member 151b are formed through-hole-type protrusion guide 112a, 112b respectively, and in a vicinity of an outer end of the protrusion guide 112a, 112b are formed supporting protrusions 114a, 114b for supporting one end of a spring forming a first pressing means 152a and a second pressing means 152b respectively. The protrusion guide 112a, 112b are for limiting rotations of the first tilt-pressing member 151a and the second tilt-pressing member 151b, which will be described below, and comprise bent portions 113a, 113b for allowing the first tilt-pressing member 151a and the second tilt-pressing member 151b to rotate along a limited section while moving. Due to the bent portions 113a, 113b, the first tilt-pressing member 151a and the second tilt-pressing member 151b can rotate respectively in necessary locations.

Thus the first tilt-pressing member 151a and the second tilt-pressing member 151b change an opening angle with respect to the first guide surface 122 and the second guide surface 124 facing each other according to a position of the slide body 130 inserted between the first tilt-pressing member 151a and the first guide surface 122 and between the second tilt-pressing member 151b and the second guide surface 124 facing each other, and can press the slide body 130 toward one side with respect to the first guide surface 122 and the second guide surface 124 facing each other.

As shown in FIGS. 3 and 4, in the other end of the first tilt-pressing member 151a is formed a first bending portion 151c. The first bending portion 151c pushes and moves the slide body 130 toward the second guide surface 124 at a position where the first guide surface 122 ends. Of course, when the size of the slide body 130 is large, even without the first bending portion 151c the center of the slide body 130 may be inclined toward the second guide surface 124, but if the size of the slide body 130 gets larger the size of the other components and the force for moving must become larger. The first bending portion 151c also performs a function of holding the slide body 130 so as not to move by pressing against one side of the second tilt-pressing member 151b. Of course, it is not necessarily required that the first bending portion 151c press the slide body 130 against one side of the second tilt-pressing member 151b, and it is also possible that other structure may be formed in a vicinity and then the slide body 130 may be held so as not to move by pressing against the other structure. This also applies to the second bending portion 151d. Since, if the slide body 130 moves, other components or objects connected to the slide body 130 move, and such movements lowers the quality of the device, it is important to hold the slide body 130 so as not to move. Of course, it is not necessarily required to hold the slide body 130 as not to move, and movement of the slide body 130 may be allowed if necessary.

Similarly, at the other end of the second tilt-pressing member 151b is formed the second bending portion 151d for holding the slide body 130 at a position where the second guide surface 124 ends so as not to move by pressing against one end of the first tilt-pressing member 151a after pushing and moving toward the first guide surface 122.

A slide module 100 according to the present invention comprises a slide body 130. The slide body 130 is installed so as to move slidably along a perimeter of the guide portion 120. In this embodiment, it moves to the first direction (downward in the figure) along the first guide surface 122, rotates by 180 degrees at a lower portion of the first guide member 128, moves to the second direction (upward in the figure) along the second guide surface 124, rotates again at an upper portion of the first guide member 128, and then returns to its original position. The slide body 130 is preferably circular, but in cases it may be elliptical, oval, wedge-shaped, triangular, or of other shapes. Such a slide body 130 is connected to the first guide member 134 through the connecting member 132, and is able to rotate in a direction at both ends of the first guide member 128. In order for the slide body 130 to be able to rotate at both ends of the first guide member 128, the first guide member 134 may be installed so as to rotate to the first guide member 128 or the connecting member 132 may be connected to the first guide member 134 rotatably. The slide body 130 is connected by the connecting member 132 preferably so as to come together against a facing guide surface.

A slide module 100 according to the invention comprises a tilt-pressing device for pressing the slide body 130 in a direction toward the guide surface.

The tilt-pressing device comprises a tilt-pressing member. The tilt-pressing member is installed so as to move and rotate in a limited section at a location away from the guide surface, that is, along the protrusion guide 112a, 112b. The tilt-pressing member changes an opening angle with respect to the guide surface according to the position of the slide body 130 inserted between the tilt-pressing member and the first and second guide surface 122 and 124, and presses the slide body 130 toward one side with respect to the guide surface. Thus the slide body 130 moves along the guide surface from a first position where the interval between the tilt-pressing member and the guide surface is smaller to a second position where the interval is larger. Such a movement of the slide body 130 is obtained by cooperation of the slide body 130, the tilt-pressing device, and the guide surface. The tilt-pressing device further comprises a pressing means for pressing the tilt-pressing member toward the guide surface.

More specifically, in this embodiment, the tilt-pressing device comprises a first tilt-pressing device 150a for pressing the slide body 130 against the first guide surface 122 and a second tilt-pressing device 150b for pressing against the second guide surface 124.

The first tilt-pressing device 150a comprises the first tilt-pressing member 151a and the first pressing means 152a. Likewise, the second tilt-pressing device 150b comprises the second tilt-pressing member 151b and the second pressing means 152b. The first tilt-pressing member 151a and the second tilt-pressing member 151b have the same structure of an integrated connection of the a vertical portion extending in a direction of length of the first guide surface 122 and a first horizontal portion and a second horizontal portion (protrusion; 155a, 155b), each extended horizontally from the top end and middle end of the vertical portion, forming a shape of letter “F” approximately. Also, the first tilt-pressing member 151a and the second tilt-pressing member 151b comprise connecting protrusions 154a, 154b formed on a top surface of the first horizontal portion in a vicinity of a location bordering with the vertical portion. The first tilt-pressing member 151a and the second tilt-pressing member 151b are disposed with each vertical portions back-to-back having the guide portion 120 inbetween, in which one surface of the vertical portion becomes a tilt-pressing surface 153a.

The pressing means 152a, 152b is configured to be contracted by an external force delivered through the tilt-pressing members 151a, 151b and return by its own elasticity, applying a pressing force to the tilt-pressing members 151a, 151b. It may comprise an elastic member of various types, for example, a spring. In the pressing means 152a, 152b embodied by spring, both ends engage the connecting protrusions 154a, 154b and the supporting protrusions 114a, 114b rotatably, respectively. The protrusions 155a, 155b protruding outward from the first tilt-pressing member 151a and the second tilt-pressing member 151b respectively prevent the first tilt-pressing member 151a and the second tilt-pressing member 151b from flipping over while receiving pressing force from the pressing means 152a, 152b, and make it perform a stable rotation on a bottom surface in the first body 110.

The size, number, supporting position of the spring used for the pressing means of the first tilt-pressing device 150a and the second tilt-pressing device 150b may be different from each other, and furthermore the roughness, slope, etc. thereof may be applied differently for the invention.

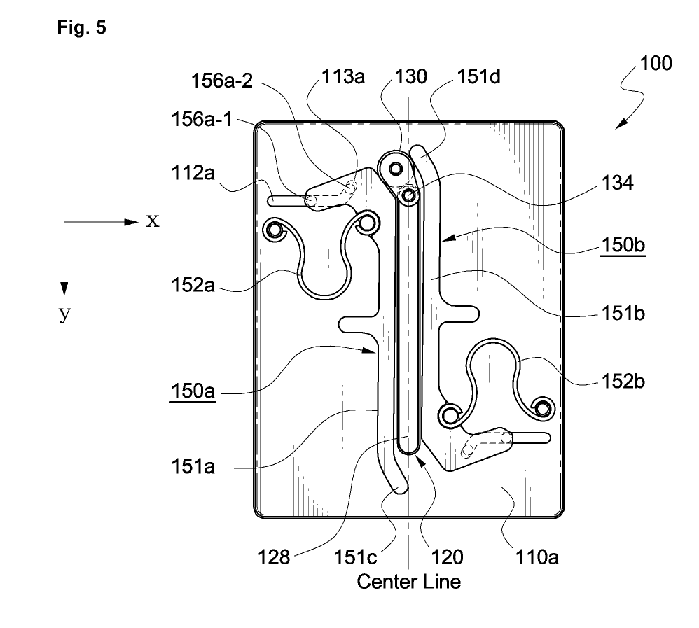

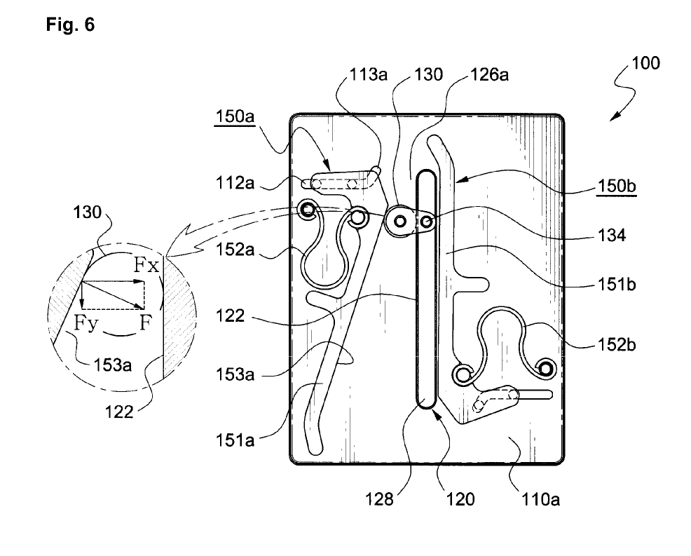

Referring to FIG. 2, the first tilt-pressing member 151a and the second tilt-pressing member 151b comprise a pair of protrusions 156a-1, 156a-2 and 156b-1, 156b-2 formed on a bottom surface of the first horizontal portion, respectively. The pair of protrusions 156a-1, 156a-2 is engaged to the protrusion guide 112a with an interval, and one protrusion 156a-1 can move over about half of the linear section of the protrusion guide 112a, and the other protrusion 156a-2 can move over the remaining section of the linear section and the entire section of the bent portion 113a. When the protrusion 156a-2 is positioned at an end portion of the bent portion 113a (refer to FIG. 5), the vertical portion of the first tilt-pressing member 151a, that is, the tilt-pressing surface 153a is in a state touched and disposed by the first guide surface 122 almost side by side. In such a state, as an external force is applied and the slide body 130 wedges in between the tilt-pressing surface 153a and the first guide surface 122, the protrusion 156a-2 passes the bent portion 113a completely, moves up to a vicinity of about half of the linear portion of the protrusion guide 112a (at this moment the protrusion 156a-1) moves to a vicinity of an end portion of the linear section of the protrusion guide 112a, and then returns again to the original position. In this process the first tilt-pressing member 151a rotates by a specific angle (in this state, the interval between the tilt-pressing surface 153a and the first guide surface 122 gets wider and wider as going down), and then returns to an original state in which the tilt-pressing surface 153a touches and lies by the first guide surface 122 side by side (refer to FIGS. 6-8). The other pair of protrusions 156b-1, 156b-2 move just as in the above.

The first tilt-pressing member 151a of the first tilt-pressing device 150a comprises a tilt-pressing surface 153a facing the first guide surface 122. The tilt-pressing surface 153a presses the slide body 130 inserted between the first guide surface 122 and itself toward a direction against the first guide surface 122, and moves the slide body 130 in a first direction along the first guide surface 122 from a location where the interval with respect to the first guide surface 122 is small to a location where the interval with respect to the first guide surface 122 is large. The first tilt-pressing member 151a is pressed toward the first guide surface 122 by the first pressing means 152a comprising a spring or the like. The second tilt-pressing member 151b of the second tilt-pressing device 150b comprises a tilt-pressing surface 153b facing the second guide surface 124. The tilt-pressing surface 153b of the second tilt-pressing member 151b presses the slide body 130 inserted between the second guide surface 124 and itself toward a direction against the second guide surface 124, and returns the slide body 130 in a second direction along the second guide surface 124 from a location where the interval with respect to the second guide surface 124 is small to a location where the interval with respect to the second guide surface 124 is large. The second tilt-pressing member 151b is pressed toward the second guide surface 124 by the second pressing means 152b comprising a spring or the like. As shown in FIGS. 1-4, in this embodiment, the spring which is included in each of the first pressing means 152a and the second pressing means 152b is preferably installed so as to press a location slanted to an end of the first tilt-pressing member 151a and the second tilt-pressing member 151b, that is, a direction in which the slide body 130 is inserted between the first tilt-pressing member 151a and the first guide surface 122 and between the second tilt-pressing member 151b and the second guide surface 124 by an external force in a stationary state and starts to move.

The tilt-pressing surfaces 153a, 153b may be pressed and touched with the guide surface facing or have a small slope while the slide body 130 is not inserted between the guide surface and itself.

Here, a U-shaped spring is used for the first pressing means 152a and the second pressing means 152b, but springs having other shapes may be used. In order to increase elasticity, springs overlapped on top of each other may be used. Furthermore, in a special case, for the first pressing means 152a and the second pressing means 152b may be used a gas spring or other types of elastic members. Also, in a general industrial machines such as a milling machine may be used a cylinder device such as a solenoid device, pneumatic cylinder device, air-pressure cylinder device, etc.

Preferably, a slide module 100 according to the invention comprises a second body 170. The second body 170 is connected to the first body 110 with the first tilt-pressing member 151a, the second tilt-pressing member 151b, and slide body 130 described inbetween, forming a union body 110a for receiving them inside.

In case that the union body 110a is formed by engaging the first body 110 and the second body 170 as in the above, an open portion for delivering the power of the slide body 130 to outside must be formed at least at an end of the union body 110a. The open portion may be formed in any location on the first body 110 and the second body 170. In a certain embodiment where there is a room in a direction of thickness, the open portion may be formed at a side portion where the first body 110 and the second body 170 are connected.

The first tilt-pressing device 150a and the second tilt-pressing device 150b may be installed in any side of the first body 110 or the second body 170, or supported by both sides thereof and installed, or in a special case they may be installed at a body where the slide module 100 according to the invention is installed. This is true because it is required just to keep the disposition relationship of the first tilt-pressing device 150a and the second tilt-pressing device 150b with respect to the first guide surface 122 and the second guide surface 124.

In an embodiment of making the slide module 100 according to the invention as shown in FIGS. 1 and 2, it may be easily installed between the two bodies.

Of course, the present invention may be realized even without the second body 170. For example, the slide module 100 according to the invention without the second body 170 may be used by attaching the first body 110 to a desired location while keeping the slide body 130, etc. inside facing a location where to attach the first tilt-pressing member 151a, etc.

FIGS. 5-10 are plan views showing the step-by-step operation of the slide module of FIG. 1. it is described also referring FIGS. 1-4.

FIG. 5 shows a first stationary state in which the slide body 130 stops at an upper end of the guide portion 120. In this state, while being put to the left, that is, on a top portion of the guide portion 120 at a location slightly slanted toward the first guide surface 122 from a center line of the guide portion 120, the slide body 130 is limited so as not to move by a tilted end portion at a border of the first horizontal portion and the vertical portion of the first tilt-pressing member 151a and the second bending portion 151d of the second tilt-pressing member 151b. In this state, if an external force larger than the holding force of the first stationary state is applied to the first guide member 134 downward (+y direction) through a member (an object to move, or its part, or a third member connected to them) connected to the first guide member 134, the slide body 130 rotates counterclockwise about the first guide member 134 as a center, and proceeds between the tilt-pressing surface 153a of the first tilt-pressing member 151a and the first guide surface 122. During such a procession or entry, a pair of protrusions 156a-1, 156a-2 slanted to the right of the protrusion guide 112a move to the left along the bent portion 113a and the linear section, and the first tilt-pressing member 151a is pushed to the left, rotates clockwise, and moves a little downward, opening the wider with respect to the first guide surface 122 as going from a top side to a bottom side as shown in FIG. 6. In an initial state of procession, the first pressing means 152a is contracted and deformed storing an elastic energy. The external force acting section 126a is the section from a location of the first stationary state in FIG. 5 to a location where the slide body 130 starts to move downward by a pressing force applied by the first tilt-pressing member 151a without an external force as shown in FIG. 6. In other words, the external force acting section is from the location of the first stationary state to a location of the slide body 130 where the changing direction of the pressing force that the tilt-pressing surface 153a applies to the slide body 130 points toward a perpendicular line direction. The external force acting section 126a is much shorter than a half of the entire length of the first guide surface 122, and may be shorter than one quarter thereof. The same may hold true for the second guide surface 124.

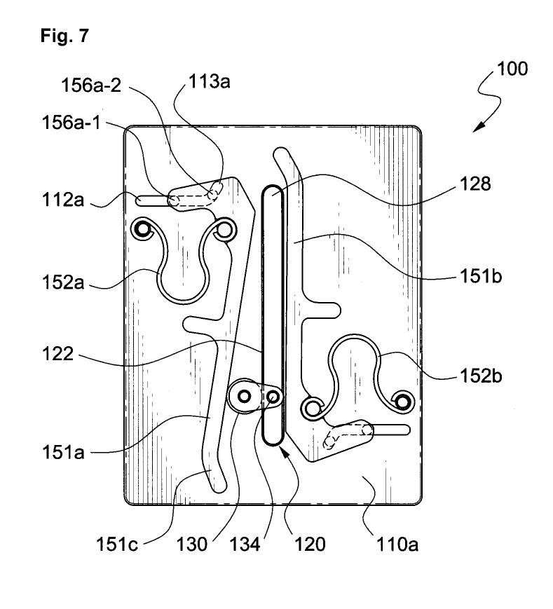

In a state of FIG. 6, that is, when the slide body 130 proceeds by an external force between the tilt-pressing surface 153a and the first guide surface 122 and passes at least an end position of the external force acting section 126a, the slide body 130 is tilt-pressed downward by the tilt-pressing surface 153a of the first tilt-pressing member 151a which is pressed toward the first guide surface 122 by the first pressing means 152a. The pressing force that the tilt-pressing surface 153a applies to the slide body 130 is a sum (F) of the vertical (+x direction) force (Fx) and the horizontal (+y direction) force (Fy) to the first guide surface 122. By this, the slide body 130 and the first guide member 134 are guided by the first guide surface 122 and the first guide member 128 and move downward as shown in FIG. 7 by the force (Fy) pointing downward (+y direction, i.e., proceeding direction). In a process of moving the slide body 130 along the first guide surface 122, the first tilt-pressing member 151a, in reversed order, rotates as going from the top portion to the bottom portion, pushing ahead to the right serially, elevating slight upward (at this moment, the pair of protrusions 156a-1, 156a-2 move to the right following the protrusion guide 112a), and after the leading protrusion 156a-2 reaches an end of the bent portion 113a the first tilt-pressing member 151a rotates further counterclockwise.

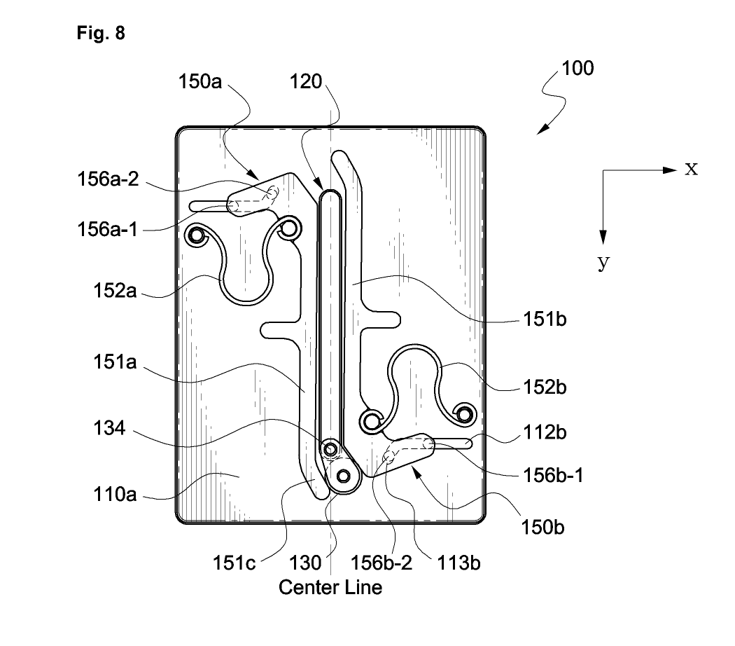

If the slide body 130 goes down along the linear section of the first guide surface 122 and reaches the bottom end, the slide body 130 is pressed toward the second guide surface 124 by the first bending portion 151c of the first tilt-pressing member 151a. By that, the slide body 130 rotates counterclockwise about the first guide member 134 as a center, crosses over a center line of the guide portion 120 as shown in FIG. 8, and reaches the second stationary state where it is put on the curved section of the second guide surface 124. In this second stationary state, the slide body 130 is locked by the first bending portion 151c of the first tilt-pressing member 151a and a tilted surface of the second tilt-pressing member 151b an kept in a limited state so as not to move further.

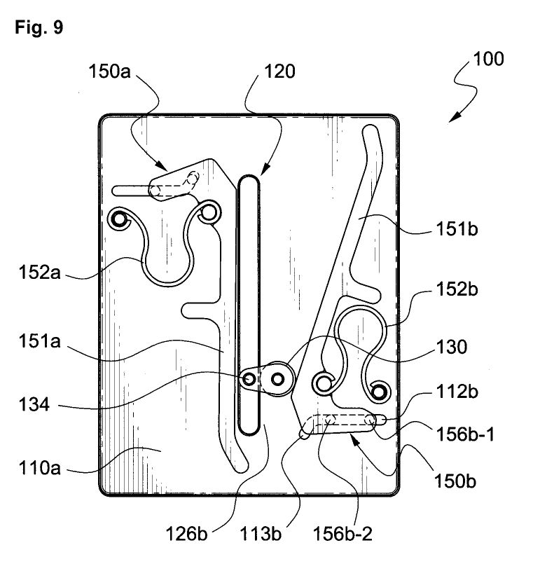

As the slide body 130 moves along the first guide surface 122 by a triggering of external force and structural mechanism from the first stationary state of FIG. 5 to the second stationary state of FIG. 8, the slide body 130 in the second stationary state of FIG. 8 is also able to move along the second guide surface 124 to the original first stationary state of FIG. 5. If the external force is applied to the first guide member 134 upward (−y direction) in a second stationary state of FIG. 8 and it is dragged upward in the first guide member 128, the slide body 130 performs a movement in the external force action section 126b. That is, it rotates about the first guide member 134 as a center, moves upward, and then wedges in between the second tilt-pressing member 151b and the second guide surface 124. By that, the second tilt-pressing member 151b moves a little to the upper-right direction along the protrusion guide portion 112b, rotates clockwise by action of the protrusions 156b-1, 156b-2 and the bending portion 113b while moving to the right, and gets into the state shown in FIG. 9. At that moment, the second pressing means 152b contracts and stores elastic energy. The external force action section 126b is the section from the state of FIG. 8 to the location right before the slide body 130 moves in a direction upward by the action of the second tilt-pressing member 151b even without external force as shown in FIG. 9.

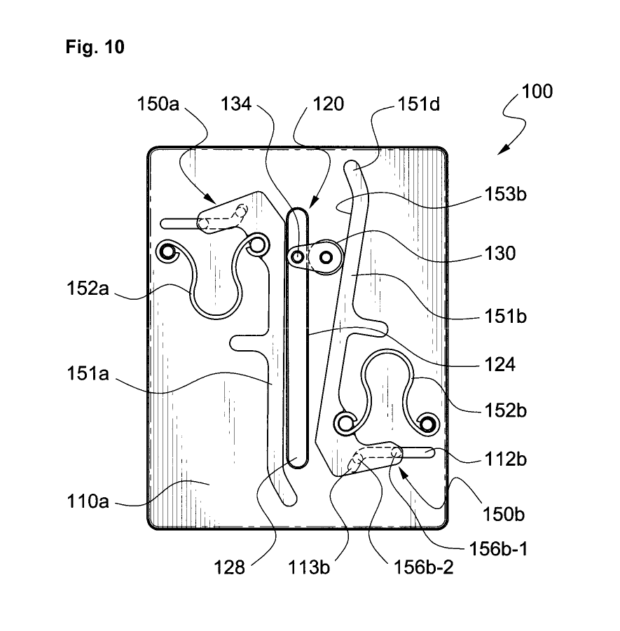

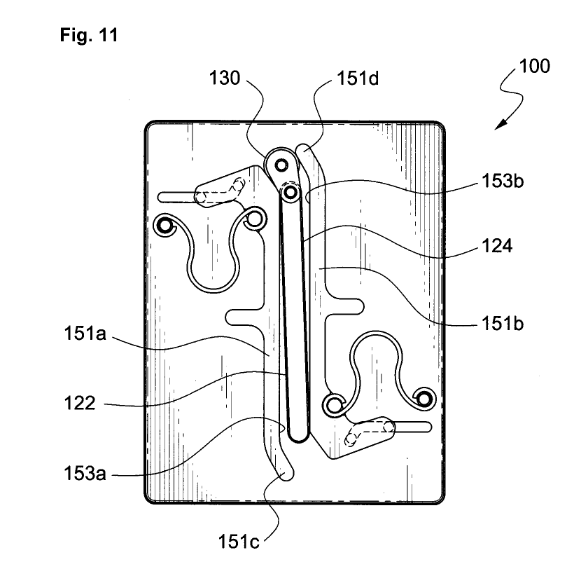

In the state of FIG. 9, the slide body 130 is tilt-pressed upward by the tilt-pressing surface 153b of the second tilt-pressing member 151b. By this, the slide body 130 and the first guide member 134 are guided by the second guide surface 124 and the first guide member 128 respectively, and move upward as shown in FIG. 10. As the second tilt-pressing member 151b is pressed toward the second guide surface 124 by the second pressing means 152b, moves the slide body 130 upward by this force, moves to the left as the protrusions 156b-1, 156b-2 moves to the left with the protrusion guide portion 112b, and rotates counterclockwise and returns to the initial position as the protrusion 156b-2 proceeds into the bending portion 113b.

The slide body 130 is pressed toward the first guide surface 122 by the second bending portion 151d of the second tilt-pressing member 151b after reaching the top end of the linear portion of the second guide surface 124. By that, the slide body 130 rotates about the first guide member 134 as a center counterclockwise along the curved portion of the second guide surface 124, passes over the center line of the guide portion 120 as shown in FIG. 5, and is disposed slantedly toward the curved portion of the first guide surface 122. This state is the first stationary state, and the slide body 130 is put on the curved portion of the first guide surface 122, being kept in a state held and limited by the second bending portion 151d of the second tilt-pressing member 151b and the guide surface of the first tilt-pressing member 151a so as not to move.

As described in the above, if a minimum of external force is applied downward enabling it to escape the external force acting section 126a from the first stationary state of FIG. 5, the slide body 130 rides down the first guide surface 122 and moves to the point of reaching the second stationary state of FIG. 8. Also, if a minimum of external force is applied upward enabling it to escape the external force action section 126b from the second stationary state, the slide body 130 rides up the second guide surface 124 and returns to the original first stationary state. When an object to move, which is connected to the first guide member 134, performs opening and closing operations, such a movement of the slide body 130 corresponds to the opening operation and the closing operation, respectively. As can be seen from the above description, the slide module 100 according to the invention has distinct features differentiating itself from the prior arts.

Firstly, the slide body 130 uses different guide surfaces for moving from the first stationary state to the second stationary state and moving from the second stationary state to the first stationary state. Like this, while the slide body 130 circumnavigates around the closed path having a shape of athletics track, the object for moving connected to the slide module 100 according to the invention reciprocates along a single linear path. This point can satisfy a special requirement that a pressing force exerted when the slide body 130 moves riding the first guide surface 122 be different from a pressing force exerted when riding the second guide surface 124.

Secondly, the external force acting section is drastically shorter than the prior arts. Therefore, the external force for initiating the movement of the slide body 130 in a stationary state needs to be exerted for a short time only. This point increases convenience of usage when the slide module 100 is applied to a mobile device including a slide phone, etc.

Thirdly, since the tilt-pressing member tilt-presses the slide body 130 while rotating and moving slightly up and down (in a direction of y axis), the distance by which the slide body 130 is moved is much longer than that of the prior arts. This point increases the range of application of the slide module 100.

FIG. 11 is a plan view showing a variant of the slide module of FIG. 1. As illustrated, if the interval between the first guide surface 122 and the tilt-pressing surface 153a gets wider as going down in a stationary state, when an external force is applied, the slide body 130 can move riding the first guide surface 122 more easily. The case of returning from the second stationary state to the first stationary state is the same. Considering this, any one or both of the first guide surface 122 and the second guide surface 124 may be formed slantedly with respect to the tilt-pressing surfaces 153a, 153b of the first tilt-pressing member 151a or the second tilt-pressing member 151b, such that the slide body 130 moves more easily along the guide surface. The rest is same as described referring to FIGS. 1-4.

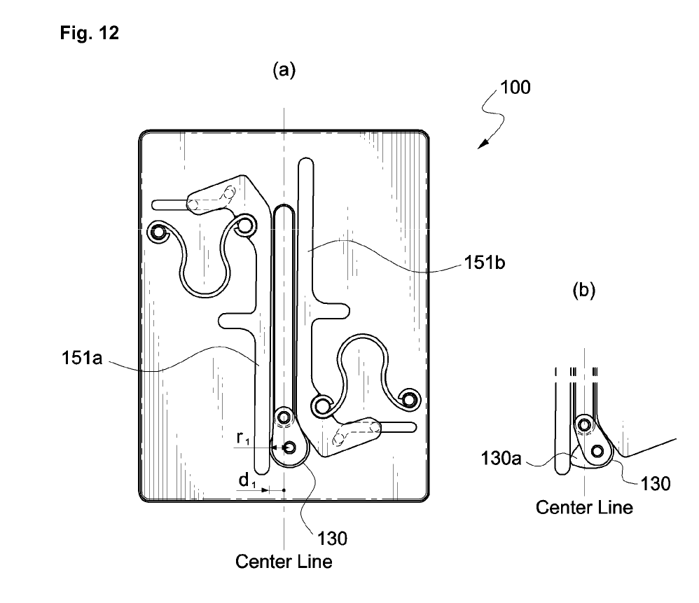

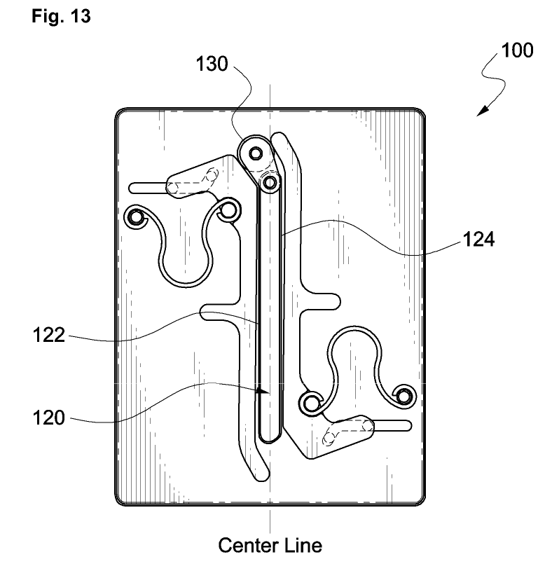

FIGS. 12 and 13 are plan views showing another variants of the slide module of FIG. 1. The center of the slide body 130 has to be disposed at the left side of the center line, that is, at a position of the curved portion of the first guide surface 122 in the first stationary state, and at the right side of the center line, that is, at a position of the curved portion of the second guide surface 124 in the second stationary state. In the previous embodiment, this requirement was satisfied by providing the first and second bending portions 151c, 151d at the ends of the vertical portion of the first and second tilt-pressing members 151a, 151b respectively. And, the above requirement may be satisfied, as shown in FIG. 12(a), by straightening the first and second bending portions 151c, 151d of the ends of the first and second tilt-pressing members 151a, 151b and making the radius (rl) of the slide body 130 larger than the minimum possible distance (dl) from the center line of the guide portion 120 to the tilt-pressing surface 153a (or the tilt-pressing surface 153b). Alternatively, as shown in FIG. 12(b), the same effect can be obtained by making the slide body 130 in a shape of egg having a more protruded portion 130a toward outside, for example, at a partial section of the circular body. The size of the circular body may be smaller than the above method.

The shape of the top and bottom ends of the guide portion 120 may be made to asymmetrical slanted surface or slanted curved surface instead of a symmetrical curved surface. Referring to FIG. 13, the top end portion of the guide portion 120 is made for the slope of the slanted surface or the slanted curved surface on the side of the first guide surface 122 to be steeper than the slope of the slanted surface or the slanted curved surface on the side of the second guide surface 124 from the center line as a reference, and likewise the bottom end portion of the guide portion 120 is made for the slope of the slanted surface or the slanted curved surface on the side of the second guide surface 124 to be steeper than the slope of the slanted surface or the slanted curved surface on the side of the first guide surface 122 from the center line as a reference. If done that way, when an external force is applied in the first stationary state, it guarantees to proceed toward the first guide surface (to proceed toward the second guide surface in the case of the second stationary state) rather than toward the second guide surface 124. The rest is same as described referring to FIGS. 1-4.

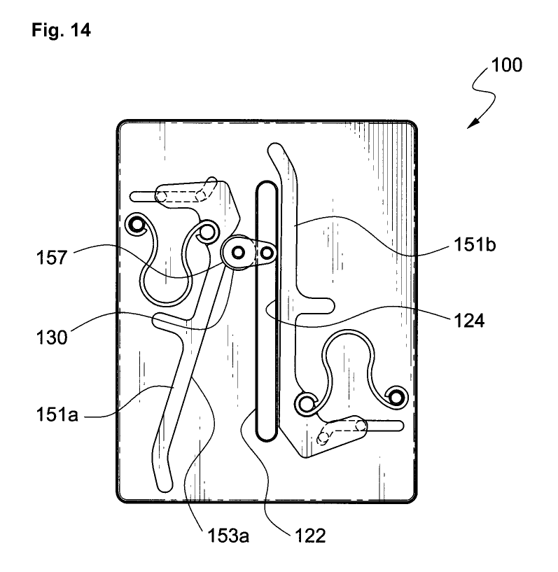

FIG. 14 is a plan view showing still another variant of the slide module of FIG. 1. In certain embodiments of application of the slide module 100, it is needed that the slide body 130 stops after moving by a certain distance from the stationary state. This variant is for such a case. Referring to the slide module 100 shown in FIG. 14, a groove 157 is formed for stopping the slide body 130 at a desired location of the tilt-pressing surface 153a of the first tilt-pressing member 151a. Instead of the groove 157, a protrusion may be formed. Such a groove 157 or protrusion can be formed also in the first guide surface 122, the second tilt-pressing member 151b and the second guide surface 124. The rest is same as described referring to FIGS. 1-4.

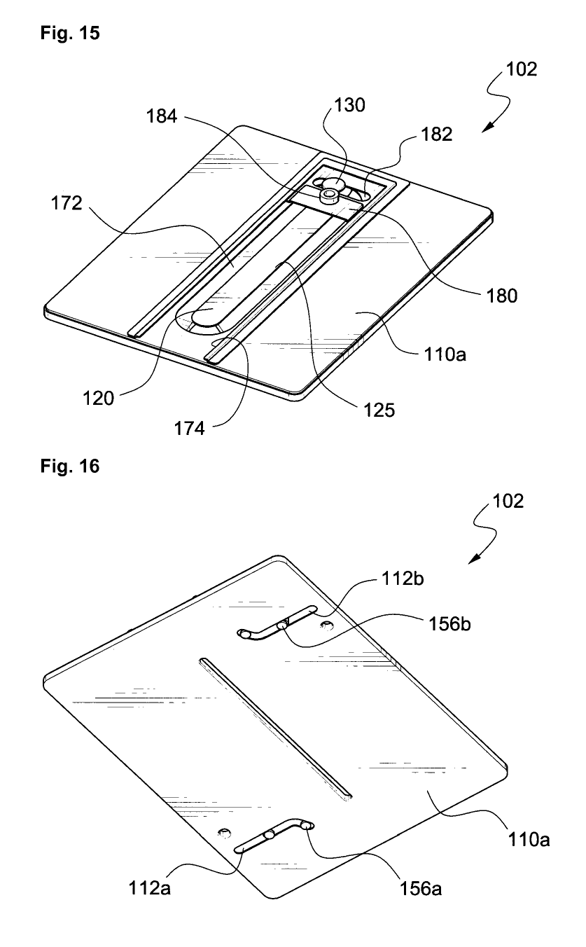

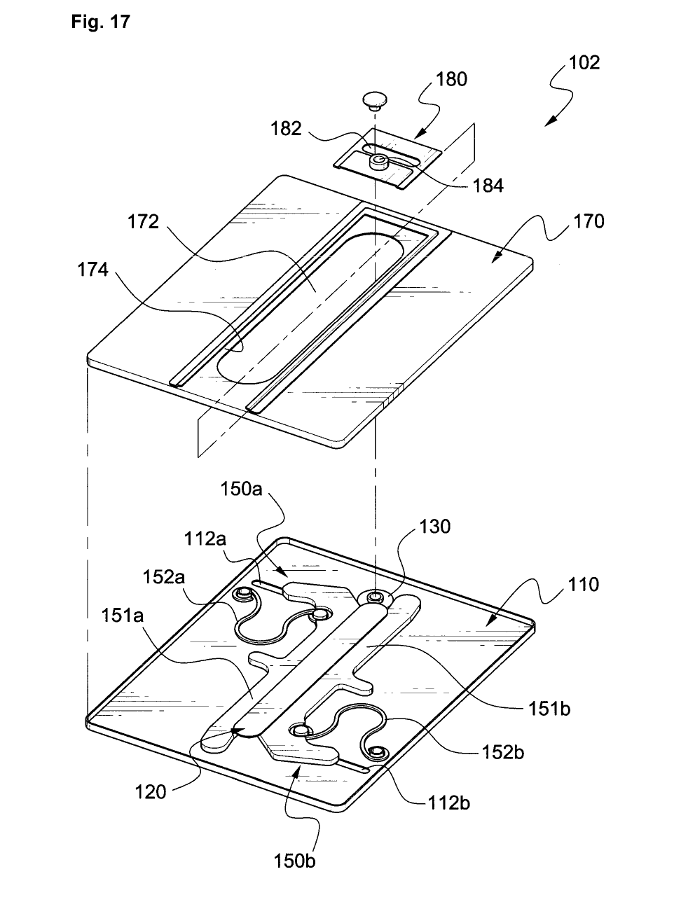

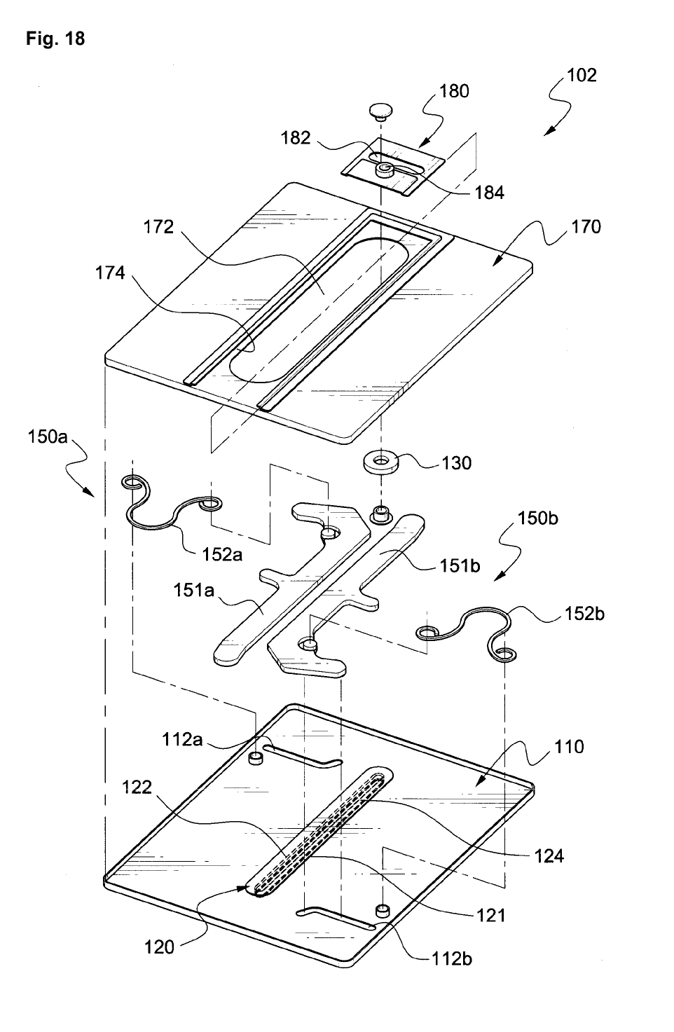

FIG. 15 is a perspective view showing a slide module according to another embodiment of the present invention, FIG. 16 is a perspective bottom view showing the slide module of FIG. 15, FIG. 17 is a perspective exploded view showing inside of the slide module of FIG. 15, and FIG. 18 is a perspective exploded view showing the slide module of FIG. 15. A slide module 102 according to embodiments shown in FIGS. 15-17 shows differences in the guide portion 120, the second body 170, and the second guide member 180 compared to the embodiment shown in FIGS. 1-4. Below, these differences will be described mainly.

As can be seen in FIGS. 15-18, the guide portion 120 installed in the first body 110 of the slide module 102 comprises a guide surface portion having a narrow width and a long length and protruded upward to a constant height forming a shape of athletic track, and a dislocation preventing portion 125 comprising and covering top ends of the guide surface portion as its own part. The guide surface portion is divided to the right and left with respect to the center line in a direction of length as a reference, the first guide surface 122 and the second guide surface 124. The surface of the first body 110 and the dislocation preventing portion 125 of the guide portion 120 form a side groove 121 along the side surface of the guide surface portion. Even though a part is inserted into the side groove 121 and receives a force upward, the slide body 130 is not dislocated upward and moves stably. In cases, the first guide surface 122 and the second guide surface 124 of the guide portion 120 may be formed so as to provide a side groove formed along the side surface or a protrusion protruding sideways. In such a case, around the side surface of the slide body 130 may be formed protrusions and grooves corresponding to the groove or the protrusion formed in the guide surface. Also, since held or limited by the second body 170, the second guide portion 174, and the second guide member 180, the slide body 130 is prevented from dislocating upward, and therefore it is not necessarily required to have the side groove 121 or protrusions.

As shown in FIGS. 15, 17, and 18, in a central portion of the second body 170 is formed an open portion 172 along a direction of length of the second guide surface 124, and along both side of the open portion 172 is formed the second guide portion 174. Here, a part disposed on perimeters of both ends of the open portion 172 prevents the slide body 130 from dislocating outward from the stationary state. And, in the second guide portion 174 is slidably installed the second guide member 180. In the second guide member 180 is formed an oblong hole 182 in a direction of width of the guide portion 120 or the second guide portion 174. Also, in the second guide member 180 is installed an engaging portion 184 for engaging an object (not shown) for the slide body 130 to move. If the second body 170 engages the first body 110, a dislocation preventing portion of the guide portion 120 is positioned in the open portion 172 providing an empty space of a shape of athletics track, and the slide body 130 circumnavigates counterclockwise along the empty space, such that the second guide member 180 performs a reciprocating sliding motion in a linear direction. The oblong hole 182 allows the slide body 130 to move in a direction of width of the first guide member 128 or the second guide portion 174 when the slide body 130 rotates along the curved portion of the guide portion 120, and to exchange a force between the slide body 130 and the second guide member 180. In such a case, even though the slide body 130 moves in a direction of width, the engaging portion 184 can perform a linear movement only, the member connected to the engaging portion 184 does not move in the direction of width, but only a linear movement. The rest is same as described referring to FIGS. 1-4.

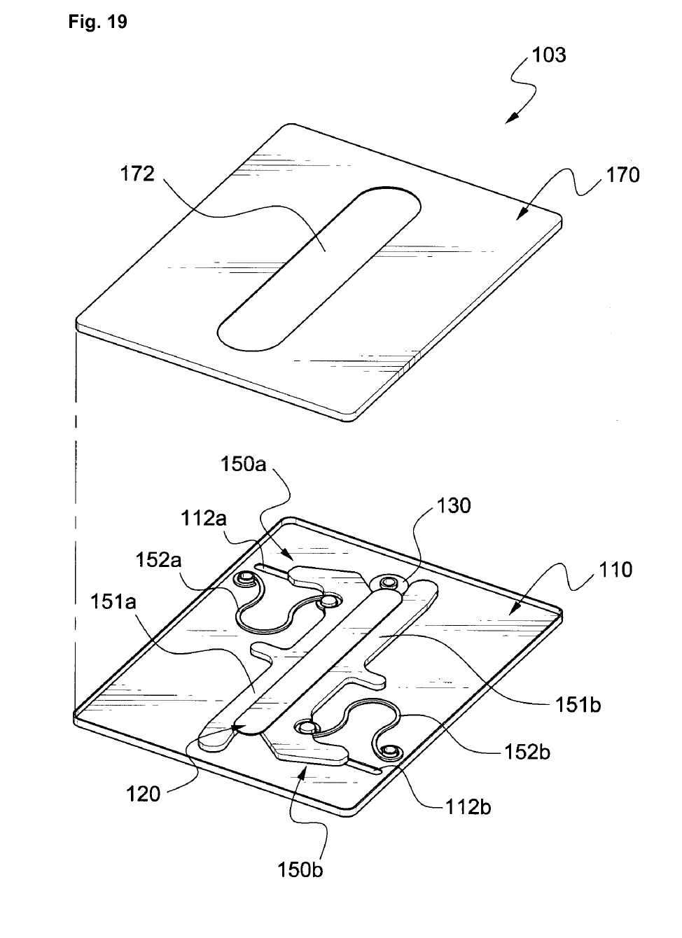

FIG. 19 is a perspective exploded view showing a variant of the slide module of FIG. 18. Referring to a slide module 103 of FIG. 19, if an oblong hole or a moving piece which allows the slide body 130 to move in a direction of width of the second guide portion 174 is installed in a member connected to the slide module 103, that is, an object to move, it may be connected directly to a member to which the power is delivered without the second guide portion 174 and the second guide member 180 described in FIG. 18. If using the second body 170, in the second body 170 has to be installed the open portion 172. The rest is same as FIG. 18.

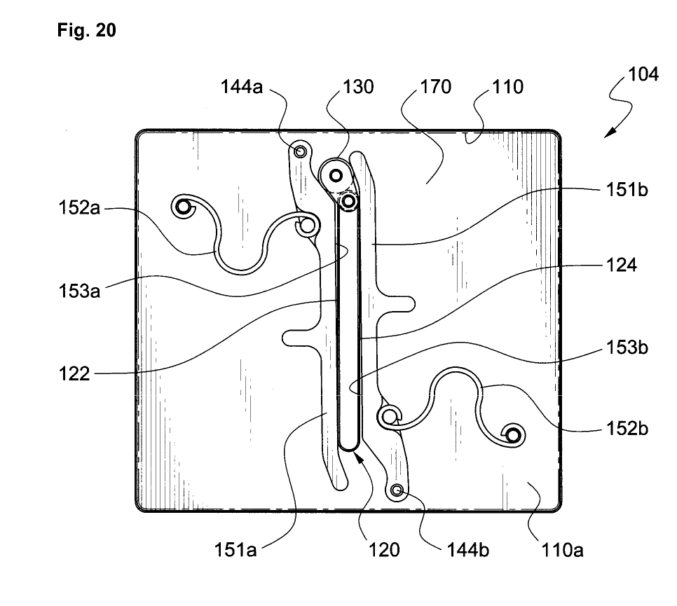

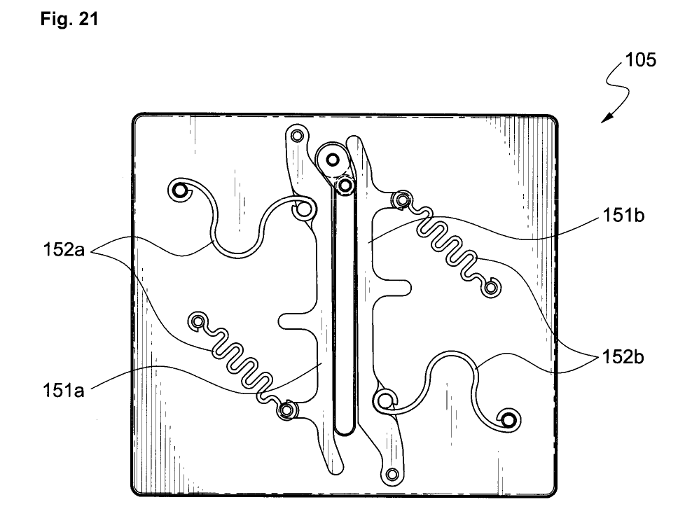

FIG. 20 is a plan view showing another variant of the slide module shown in FIGS. 1-4. Referring to a slide module 104 shown in FIG. 20, it is different from the previous embodiments in that the first tilt-pressing member 151a and the second tilt-pressing member 151b are installed such that one ends 144a, 144b thereof are fixed rotatably and it can be rotated about those. In this case, the first and second pressing means 152a, 152b can tilt-press the slide body 130 in a desired direction by pressing not only the rotational center of the first tilt-pressing member 151a and the second tilt-pressing member 151b but also its opposite side. The first tilt-pressing member 151a and the second tilt-pressing member 151b may be installed in any one of the first body 110 and the second body 170, and may be installed so as to get supported by both of them. Since when the first tilt-pressing member 151a and the second tilt-pressing member 151b are rotated the slide body 130 must be able to pass through between the first tilt-pressing member 151a and the first guide surfaces 122 and between the second tilt-pressing member 151b and the second guide surfaces 124, the rotational centers 144a, 144b of the first tilt-pressing member 151a and the second tilt-pressing member 151b must be disposed apart from the first guide surface 122 and the second guide surface 124. The tilt-pressing surfaces 153a, 153b may have one side thereof opened a little bit further against the facing guide surface, such that when the slide body 130 is positioned at the side of an end of the guide portion 120 the slide body 130 is able to be inserted between the first tilt-pressing member 151a and the first guide surface 122 and between the second tilt-pressing member 151b and the second guide surface 124 easily. Of course, the tilt-pressing surfaces 153a, 153b may be touched closely to the facing guide surface. And, springs overlapped on top of each other can be used for the first and second pressing means 152a, 152b in order to increase the pressing force. This is same as in the previous embodiments. Since when the tilt-pressing members is rotated around a fixed position as a center as shown in FIG. 19, the radius of rotation gets larger than in the previous embodiments, the width of the first body 110 and the second body 170 increases a little. The rest is same as described in FIG. 1.

FIG. 21 is a plan view showing still another variant of the slide module shown in FIGS. 1-4. Referring to a slide module 105 shown in FIG. 21, in cases, the spring used as the first pressing means 152a may support more than two locations according to the designer's choice within a range where the rotation of the first tilt-pressing member 151a is not hindered. The same is true with the second pressing means 152b. The rest is same as in FIG. 20. This is also same as in the previous embodiments.

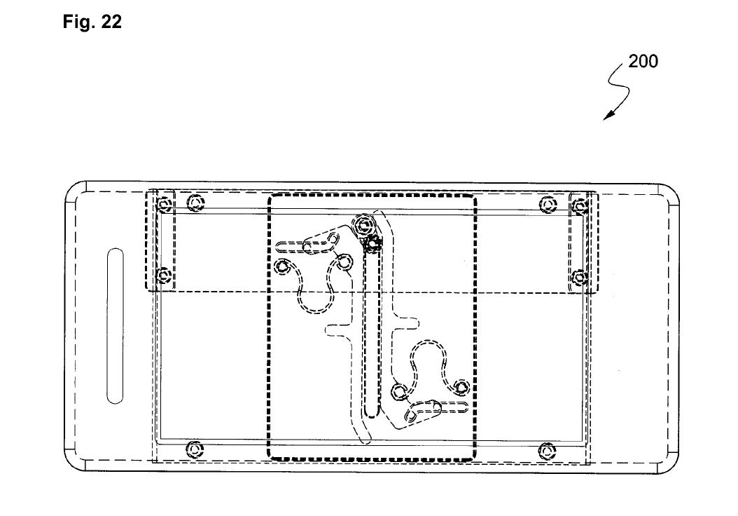

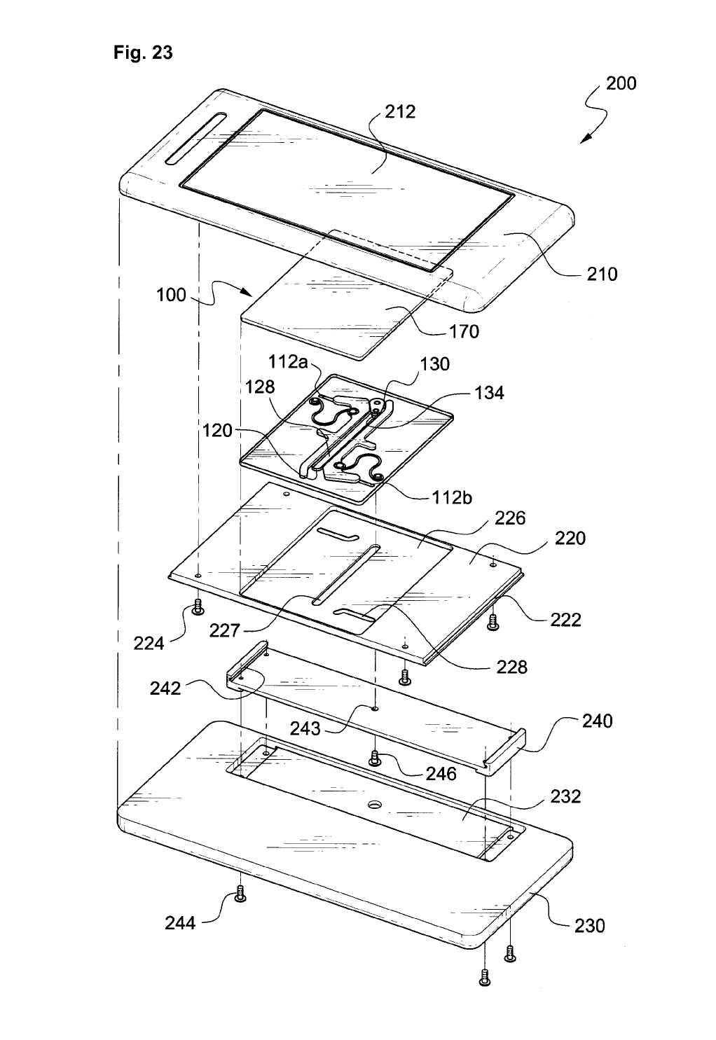

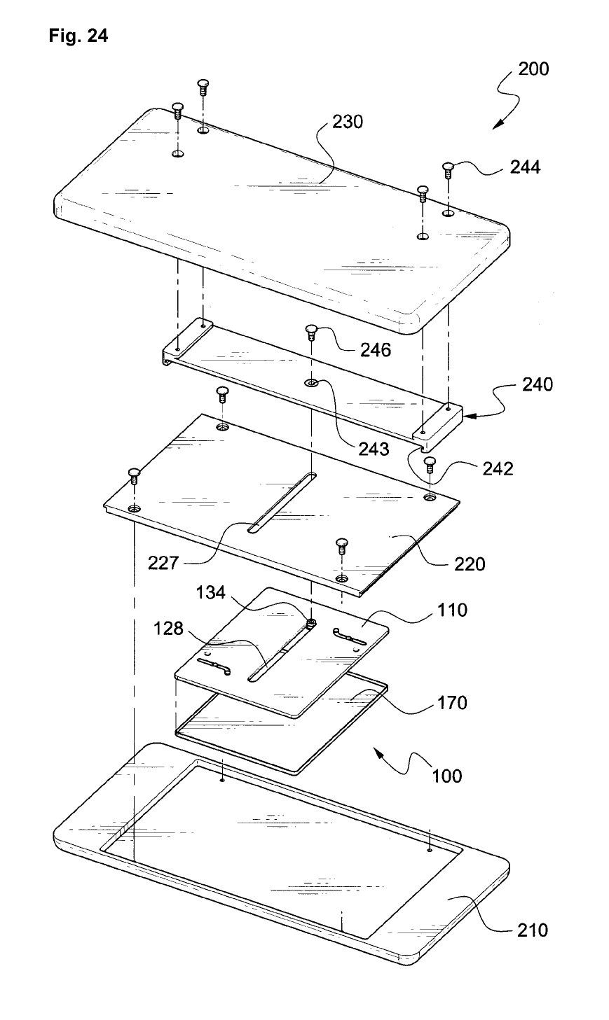

FIG. 22 is a plan view showing a mobile electronic device adopting a slide module according to the present invention, FIG. 23 is a perspective exploded view showing the mobile electronic device of FIG. 22, and FIG. 24 is a perspective exploded view showing the mobile electronic device of FIG. 23 flipped top to bottom.

A mobile electronic device 200 shown in FIGS. 22-24 comprises a first body 210. Preferably, on a top surface of the first body 210 is installed a display 212. To a bottom surface of the first body 210 is installed a slide plate 220 having guide portion 222 on both sides through a screw member 224. On a top surface of the slide plate 220 is formed a installing groove 226 for installing the slide module 100, in which there are formed holes 227 and grooves 228 corresponding to the first guide member 128 and the protrusion guide portion 112a, 112b formed in the slide module 100 respectively. Between the slide plate 220 and the first body 210 is installed the slide module 100 according to the present invention.

The mobile electronic device 200 according to the invention comprises a second body 230. In an upper portion of the second body 230 is formed an installation portion 232 for installing a guide plate 240. The guide plate 240 having the guided portion 242 formed along both perimeters is fixed to the installation portion 232 through the screw member 244. In a central portion of the guide plate 240 is formed a through hole 243, and through the through hole 243 the screw member 246 is connected to the first guide member 134. By this, the first guide member 134 is installed movably around the guide portion 120 installed fixedly to the first body 210 with respect to the first body 210, and is in a fixed state at a fixed position with respect to the second body 230.

In a reference where the first body 210 in which the slide module 100 according to the invention is upended top to bottom, the second body 230 becomes a moving member performing an up and down reciprocating movement according to an up and down movement of the slide body 130.

In cases, in a case that the second body 230 is connected directly to the slide body 130 without the guided portion 242, the second body 230 performs a closed path movement in a direction along a closed path. In a certain case, the display 212, etc. is installed on a bottom surface of the second body 230, and auxiliary components such as a main board that were installed inside of the second body 230 may be installed in the first body 210.

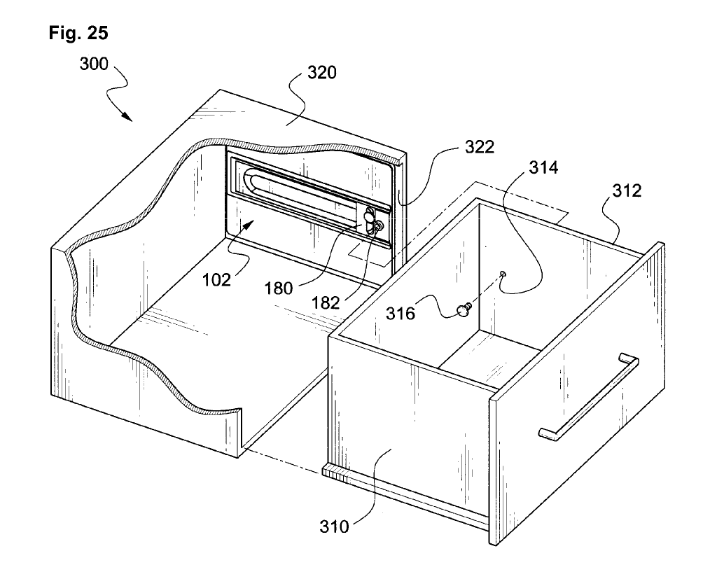

FIG. 25 is an exploded view showing a state in which a slide module according to the present invention is applied to a drawer.

As shown in FIG. 25, the slide module 102 according to the invention may be installed between a wall portion 312 of a drawer 310 and a wall portion 322 of a drawer guide portion 320 for guiding the drawer 310. That is, by attaching the slide module 102 according to the invention on the wall portion 322 of the drawer guide portion 320 and engaging the screw member 316 to the engaging portion 184 of the second guide member 180 with a hole 314 in the wall portion 312 of the drawer 310, it is possible to make an apparatus 300 such as a desk having a slide module according to the invention. The slide module 102 may be installed on both sides of the drawer 310, and more than two of them may be installed on one side.

That is, the slide module 102 according to the invention may be attached to a conventional desk having drawers to be used.

In a case of making the apparatus 300 as shown in FIG. 25, the drawer 310 is opened automatically if the user pulls it a little. And, when closing the drawer 310, if the user pushes the drawer 310 a little, the drawer 310 is closed automatically.

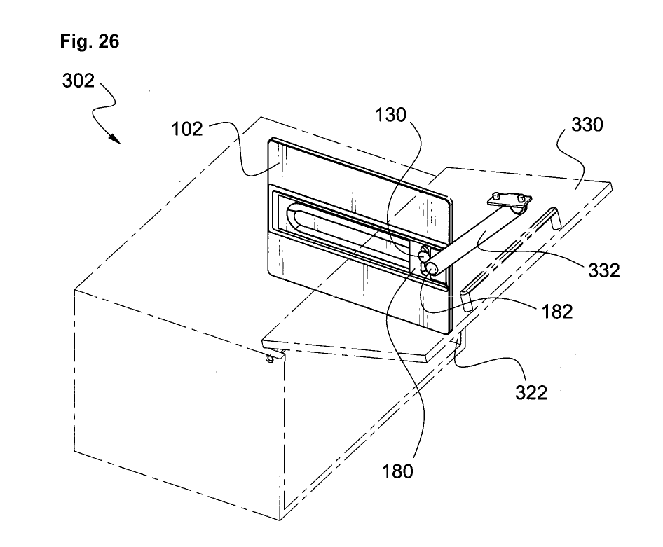

FIG. 26 is a perspective view showing a state in which a slide module according to the present invention is applied to a revolving door.

In a device 302 in which a rotational opening/closing door 330 is installed, the invention can be realized by installing the slide module 102 according to the invention in a wall portion 322 of an inner space, connecting a link 332 to the slide body 130 or the engaging portion 184 of the second guide member 180 connected to the slide body 130, and connecting the link 332 to the door 330. In such a case, considering the gravity acting on the door 330 in opening/closing the door 330, by configuring to move the slide body 130 with a large force in the first guide surface of the slide module 102 the door 330 can be made to open easily, by configuring to move or resist with a relatively very small force such that the door 330 can be closed smoothly by the gravity in the second guide surface the door 330 may be made to close easily, or by bending an end of the second guide surface it can be made such that a brake kicks in to the slide body 130 right before the door 330 closes completely. That is, in the slide module 102 according to the invention, it is possible to make a moving power of the slide body 130 in the first guide surface different from a moving power of the slide body 130 in the second guide surface. In such a case, it is also possible to apply stiffness or number of springs on both sides, roughness or surface shape of the tilt-pressing surfaces, roughness or shape of the first and second guide surfaces, etc. differently from each other.

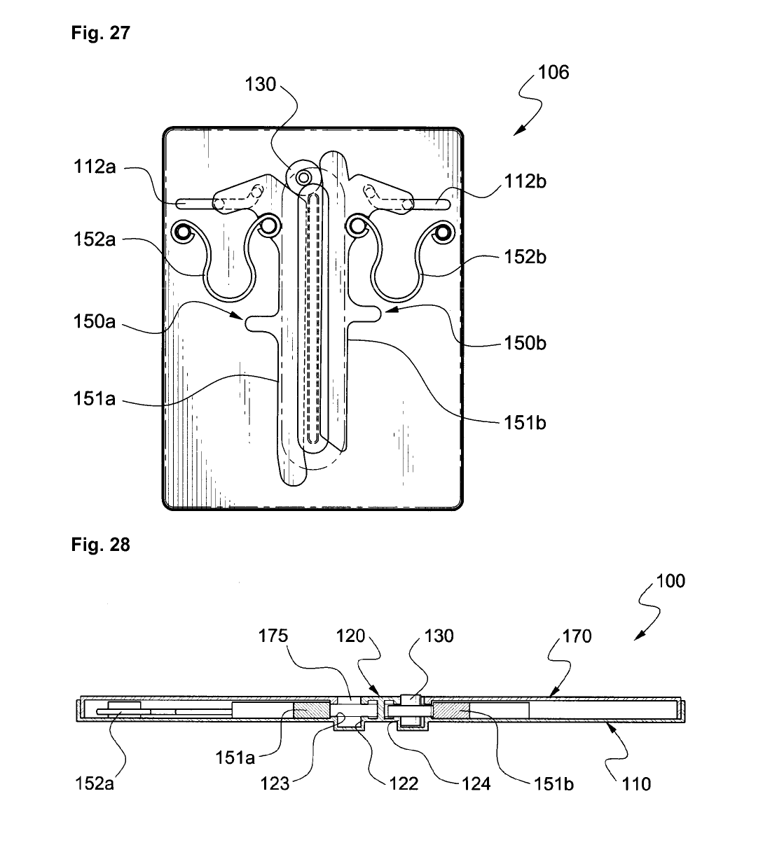

FIG. 27 is a plan view showing a slide module according another embodiment of the present invention.

As a slide module 106 for an apparatus 302 as in FIG. 26, the first tilt-pressing member 151a and the second tilt-pressing member 151b may be installed in a same direction. In such a case, the first tilt-pressing device 150a moves the slide body 130 in one direction, and the second tilt-pressing device 150b may be configured to exert a force resisting the gravity acting on the door 330 when the door 330 of FIG. 26 is closed.

In certain cases, by providing a guide portion having one guide surface, one tilt-pressing portion, and a slide body, it is possible to configure, such that the slide body 130 exerts a force in an opening direction in opening and closing the door 330. In such a case, when opening the door 330, the door 330 receives a force in the opening direction from the slide body 130, and opens with a small force. On the contrary, when closing the door 330, the door 330 receives a force resisting the gravity of the door 330 from the slide body 130, and may be configured to close smoothly. In such a case, the slide body 130 in an opened state may be made preferably to ride the guide surface used for opening when an external force is applied. In certain cases, a separate stopping means for holding the slide body 130 in a stop may be provided.

FIG. 28 is a cross-sectional view showing other example of a guide portion.

In certain cases, the guide portion 120 of the slide module 100 according to the invention may be formed in a shape of groove in the first body 110, etc. In such a case, the first guide surface 122 and the second guide surface 124 become a wall surface on one side of the groove. In the embodiment shown in FIG. 28, since the first guide surface 122 and the second guide surface 124 are installed on heights different from the first tilt-pressing member 151a and the second tilt-pressing member 151b, and since the slide body 130 may be slanted when the groove is not deep, it is preferable to form the first guide surface 122 and the second guide surface 124 for supporting the top end of the slide body 130 along with the guide portion 120. For this, in the second body 170 must be formed a hole 175 on a corresponding location. Along the guide portion 120 is formed a step 123 to which the first tilt-pressing member 151a and the second tilt-pressing member 151b are latched when the slide body 130 escapes. The rest is same as in the previous embodiments.

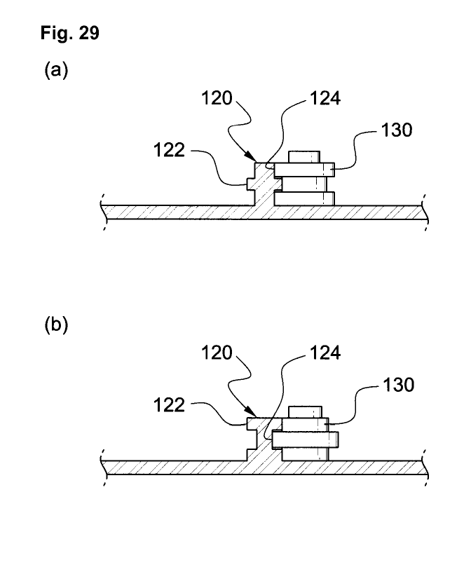

FIG. 29 is a diagram showing variants of a guide surface and a slide body.

In certain cases, as shown in FIG. 29a, the first guide surface 122 and the second guide surface 124 of the guide portion 120 provide protrusions formed along the side surface, and the slide body 130 may be configured to comprise grooves having a corresponding shape along the side surfaces.

In other cases, as shown in FIG. 29b, the first guide surface 122 and the second guide surface 124 of the guide portion 120 provide grooves formed along the side surface, and the slide body 130 may be configured to comprise protrusions having a corresponding shape along the side surfaces.

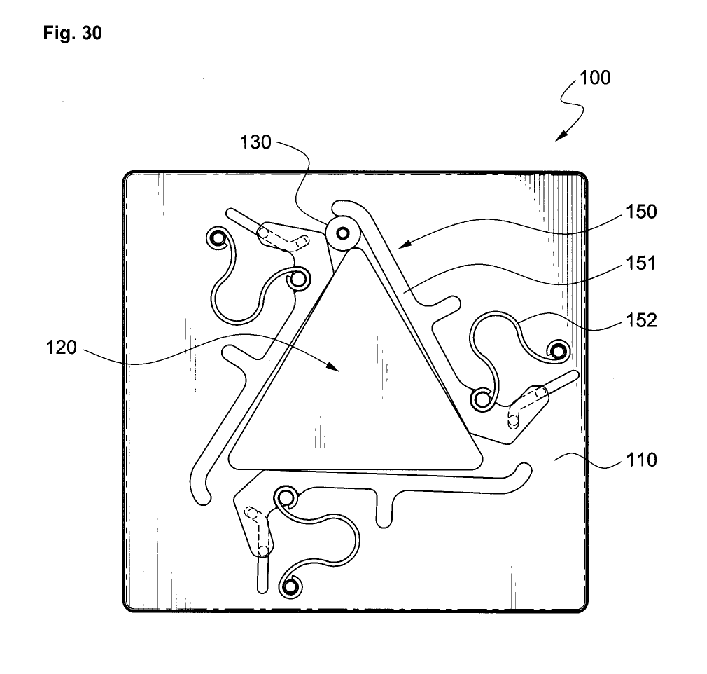

FIG. 30 is a plan view showing a slide module according still another embodiment of the present invention.

In certain cases, by forming a triangular guide portion 120 having three guide surfaces 120a along a side surface of the first body 110, etc. and forming the tilt-pressing device 150 around there respectively, it is possible to make the slide module 100, such that the slide body 130 moves along a triangular circumnavigating track. In this embodiment, the slide body 130 can stay at each of the vertex points of the triangle respectively. In order for the slide body 130 in a stationary state to proceed between the tilt-pressing member 151 supported by the pressing means 152 and the corresponding guide surface 120a, a corresponding external force must be applied as in the previous embodiments.

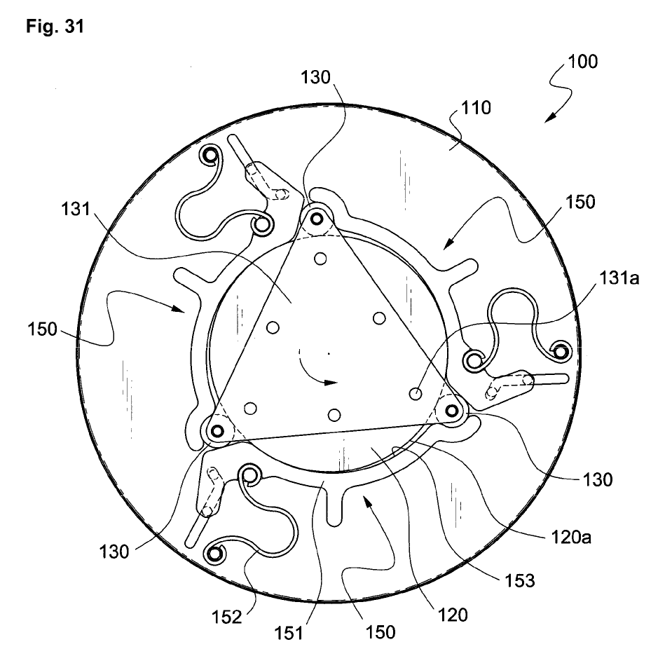

FIG. 31 is a plan view showing a slide module according to still another embodiment of the present invention.

The slide module 100 shown in FIG. 31 comprises a circular guide portion 120 formed in the first body 110, etc. In this guide portion 120 is provided a circular guide surface 120a along wall surface of the side surface.

As shown in FIG. 31, along the perimeter of the guide portion 120 are installed three tilt-pressing devices 150. Each of the tilt-pressing devices 150 provides a tilt-pressing member 151 where the tilt-pressing surface 153 forms a curved surface and a pressing means 152 for pressing toward the guide portion 120a.

In this embodiment, three slide bodies 130 are installed with intervals, and each of the slide bodies 130 is connected to one another through a connecting body 131. By this, in a case of rotating the connecting body 131 counterclockwise, a rotational power can be obtained from the three slide bodies 130, and in a case of rotating clockwise, a force resisting the rotation can be obtained from the three slide bodies 130.

And, in a case of connecting rotatably a link to the connecting portion 131a at a location off the rotational center of the connecting body 131 or any one of the slide bodies 130, the rotational motion of the connecting body 131 can be converted to a linear motion.

In the above description, the invention may be applied to the cases where the guide surface is disposed in a shape of polygon such as triangle, rectangle, etc., or along a curved surface such as circle or ellipse, and may be used to rotate an object to move.

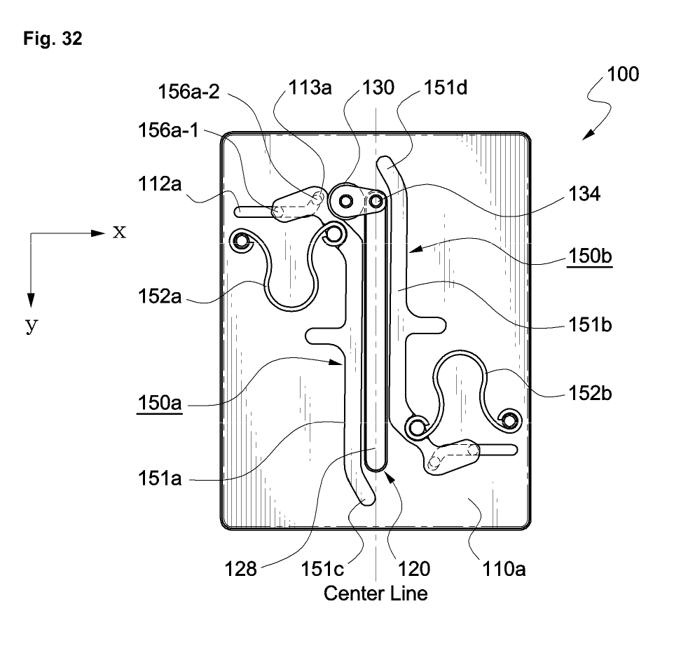

FIG. 32 is a plan view showing a variant of the slide module of FIG. 5.

Referring to FIG. 32, the slide body 130 does not have to be held at both ends of the guide portion 120 by the first tilt-pressing member 151a, the second tilt-pressing member 151b, etc. so as not to move. That is, it is possible to make an interval between the second bending portion 151d of the second tilt-pressing member 151b and the facing end portion of the first tilt-pressing member 151a and an interval between the first bending portion 151c of the first tilt-pressing member 151a and the facing end portion of the second tilt-pressing member 151b wider as in FIG. 5, such that the slide body 130 can rotate about the first guide member 134 as a center. In a state where the slide body 130 is rotated relatively more toward one guide surface, it is possible to reduce the magnitude of external force for pushing the slide body 130 between the first tilt-pressing member 151a and the first guide surface 122 or between the second tilt-pressing member 151b and the second guide surface 124 compared to the case in FIG. 5.

The rest is same as described referring to FIGS. 1-4.

In the embodiment shown in FIGS. 5 and 32, it is possible to make an external force exerted to a center of the slide body 130 by applying the second body 170 in which the second guide portion 174 is formed as shown in FIG. 18 and the second guide member 180 in which the oblong hole 182 and the engaging portion 184 are formed. In such a case, relatively small external force is needed.

### INDUSTRIAL APPLICATIONS

A slide module according to the present invention can be applied to various devices in which a slide motion is needed between two parts such as a drawer of desk, doors of an architecture or electric appliances, etc. as well as a mobile terminals such as a mobile phone, a mobile game machine, PDA, an electronic scheduler, an electronic dictionary, a notebook computer, a net-book computer, etc.

What is claimed is:

1. A slide module comprising:
a guide portion having a first guide surface and a second guide surface forming a circumnavigating track;
a slide body installed so as to circumnavigate along the circumnavigating track;
a first tilt-pressing device having a first tilt-pressing member with a first tilt-pressing surface facing toward the first guide surface and a first pressing means for pressing the first tilt-pressing member against the first guide surface; and
a second tilt-pressing device having a second tilt-pressing member with a second tilt-pressing surface facing toward the second guide surface and a second pressing means for pressing the second tilt-pressing member against the second guide surface,
wherein if the slide body proceeds between the first guide surface and the first tilt-pressing surface by an external force, the first tilt-pressing member tilt-presses the slide body with respect to the first guide surface by a pressing force provided by the first pressing means, and
wherein if the slide body proceeds between the second guide surface and the second tilt-pressing surface by external force, the second tilt-pressing member tilt-presses the slide body with respect to the second guide surface by a pressing force provided by the second pressing means.

2. The slide module of claim 1, wherein if the slide body proceeds between the first guide surface and the first tilt-pressing surface by an external force from a first stationary state at one end of the circumnavigating track, the first tilt-pressing member retreats with respect to the first guide surface, then returns to an original state by a pressing force provided by the first pressing means, and tilt-presses the slide body so as to move toward the other edge of the circumnavigating track along the first guide surface, and if the slide body proceeds between the second guide surface and the second tilt-pressing surface by an external force from a second stationary state at the other end of the circumnavigating track, the second tilt-pressing member retreats with respect to the second guide surface, then returns to an original state by a pressing force provided by the second pressing means, and tilt-presses the slide body so as to move toward the one end of the circumnavigating track along the second guide surface.

3. The slide module of claim 1, wherein if the slide body proceeds between the first guide surface and the first tilt-pressing surface by an external force from a first stationary state at one end of the circumnavigating track, the first tilt-pressing member retreats with respect to the first guide surface, then returns to an original state by a pressing force provided by the first pressing means, and tilt-presses the slide body so as to move toward the other end of the circumnavigating track along the first guide surface, and if the slide body proceeds between the second guide surface and the second tilt-pressing surface by an external force from a second stationary state at the other end of the circumnavigating track, the second tilt-pressing member tilt-presses the slide body by a pressing force provided by the second pressing means while retreating with respect to the second guide surface, acts a force interfering the slide body from moving toward the one end of the circumnavigating track along the second guide surface, and returns to the original state if the slide body overcomes the above interfering force with an external force and escapes to the first stationary state.

4. The slide module of claim 1, wherein each of the first and second guide surfaces comprises linear moving sections elongated in a direction of length and direction-changing sections bent or curved smoothly from both ends of the linear moving sections, and the direction-changing sections of the first and second guide surfaces are connected to each other, making an athletics track or similar shape.

5. The slide module of claim 1, wherein the first tilt-pressing member or the second tilt-pressing member is installed rotatably at a position distant from an end of the guide portion or moving along a limited section, and, by changing the angle tilt-opening with respect to a guide surface according to the position of the slide body inserted between the guide surface facing therewith, presses the slide body toward one side with respect to the facing guide surface.

6. The slide module of claim 1, wherein in the other end of the first tilt-pressing member is formed a first bending portion for holding the slide body by pressing the slide body against the one side of the second tilt-pressing member so as not to move after pushing and moving the slide body toward the second guide surface at a location where the first guide surface ends, and in the other end of the second tilt-pressing member is formed a second bending portion for holding the slide body by pressing the slide body against the one side of the first tilt-pressing member so as not to move after pushing and moving the slide body toward the first guide surface at a location where the second guide surface ends.

7. The slide module of claim 1, wherein at each of both ends of the circumnavigating track is provided an external force acting section for the slide body to stay at a stationary state and then proceed between the first guide surface and the first tilt-pressing member or between the second guide surface and the second tilt-pressing member by an external force.

8. The slide module of claim 1, wherein along the gap between the first guide surface and the second guide surface is formed a first guide member, and in the first guide member is installed a first guiding member, which is connected to the slide body, installed movably along the first guide member, and guides the slide body to circumnavigate the first and second guide surfaces without dislocating while moving with the slide body.

9. The slide module of claim 1, wherein the guide portion comprises a dislocation-preventing portion which covers top portions of the first and second guide surfaces, a surface of the first body and the dislocation-preventing portion form a side groove along the first and second guide surface, and the slide body is installed such that a part thereof is inserted in the side groove and glide-and-moves while inserted and trapped in the side groove.

10. The slide module of claim 1, further comprising:
a first body in which the guide portion is installed; and
a second body engaged with the first body with the first tilt-pressing device, the second tilt-pressing device, and the slide body between the first body and itself,
wherein at least in one side of the assembly of the first and second bodies is formed an open portion for delivering a power of the slide body to outside.

11. The slide module of claim 10, wherein in the second body is formed an opening in a direction of length of the first guide surface and the second guide surface, along both sides of the direction of length of the opening is formed a second guide member, in the second guide member is installed movably a second guiding member in a direction of length of the opening, in the second guiding member is formed an oblong hole for allowing the slide body to move in a direction of width of the second guide member, and the slide body is connected to the second guiding member through the oblong hole.

12. The slide module of claim 1, wherein at an end of the first tilt-pressing member or the second tilt-pressing member are disposed more than two protrusions with an interval, at least in an end of the guide portion is formed a protrusion guide in which the more than two protrusions are inserted and guided at a position away from the guide portion, and the protrusion guide comprises a bent portion allowing the first tilt-pressing member or the second tilt-pressing member to move along the limited section and to rotate.

13. The slide module of claim 1, wherein when it moves from one end of the circumnavigating track to the other end, the slide body passes a peak point of the other end and then stops, and when it moves from the other end of the circumnavigating track to the one end, the slide body passes a peak point of the one end and then stops.

14. The slide module of claim 1, wherein upper end and lower end of each of the first tilt-pressing member and the second tilt-pressing member pass and extend beyond the upper end and the lower end of the circumnavigating track, and the extended parts limit the slide body at both ends of the circumnavigating track.

15. The slide module of claim 1, wherein the first pressing means and the second pressing means comprise a spring with elasticity.

16. The slide module of claim 1, wherein the first guide surface and the second guide surface comprises grooves or protrusions formed along the side surfaces thereof, and at least a part of the slide body is engaged with the grooves or protrusions and guided thereby.

17. A slide module comprising:
a guide portion having a guide surface;
a slide body installed movably along the guide surface; and
a first tilt-pressing device having a tilt-pressing member with a tilt-pressing surface facing toward the guide surface and installed rotatably while moving around a position away from the guide surface as a center or in a limited section and a pressing means for pressing the tilt-pressing member toward the guide surface,
wherein if the slide body is inserted between the tilt-pressing surface and the guide surface, the tilt-pressing member is configured to apply a force for moving the slide body along the guide surface from a first position with a smaller interval against the guide surface to a second position with a larger interval, by pressing the slide body toward one side with respect to the guide surface by a pressing force that the pressing means provide while the angle tilt-opening against the guide surface changes.

18. The slide module of claim 17, wherein the guide surface is disposed along a shape selected from the group consisting a circle, an ellipse, and polygons, and two or more tilt-pressing devices are disposed along a perimeter of the guide portion.

19. The slide module of claim 17, wherein the guide surface is disposed along a circle, two or more first tilt-pressing devices are installed along a perimeter of the guide portion, and two or more slide bodies are installed with intervals.

20. An apparatus having a slide module comprising:
a slide module according to any one of claims 1 through 19;
a moving member which engages a slide body of the slide module or a connection member connected to the slide body and performs a linear reciprocation or circumnavigation along an arbitrary closed path or rotation; and
a supporting member for supporting the slide module such that the moving member moves according to the movement of the slide body.
